(19) United States
(12) Patent Application Publication
(10) Pub. No.: US 2015/0031452 A1
(43) Pub. Date: Jan. 29, 2015

(54) Game Controller for a Portable Computing Device

(71) Applicant: Immersa Labs, Inc., Palo Alto, CA (US)

(72) Inventors: Patrick Joseph Rundell, Palo Alto, CA (US); Cameron Erich Matzke, Palo Alto, CA (US); Luke James Baldwin-Brown, Palo Alto, CA (US)

(21) Appl. No.: 14/341,067

(22) Filed: Jul. 25, 2014

Related U.S. Application Data
(60) Provisional application No. 61/858,191, filed on Jul. 25, 2013.
(60) Provisional application No. 61/943,470, filed on Feb. 23, 2014.
(60) Provisional application No. 62/004,814, filed on May 29, 2014.

(51) Int. Cl. A63F 13/24; A63F 13/92

(52) U.S. Cl. CPC A63F 13/24; A63F 13/92
USPC 463/31; 463/37; 463/35

(57) ABSTRACT

A game controller assembly is mechanically and communicatively connected to a user computing device to be used to play games. The game controller assembly is detachable he coupled mechanically and electrically to the user computing device. For example, the user computing device may be a smart mobile phone. The game controller assembly can be mounted on the smart mobile phone and also be communicatively coupled to the smart phone for communications with the smart phone. The game controller is used to play games on the smart phone. The game controller assembly can also be used for other purposes, such as navigating web pages, watching video streams, interacting with other online users, interacting/socializing, etc.

### CROSS REFERENCE TO RELATED APPLICATIONS

This application claims the benefit under 35 U.S.C. §119(e) of U.S. Provisional Application No. 61/858,191, entitled “GAME CONTROLLER ASSEMBLY,” filed on Jul. 25, 2013, the entire contents of which are incorporated herein by reference; of U.S. Provisional Application No. 61/943,470, entitled “EXTENSIONS AND ENHANCEMENTS TO GAME CONTROLLER ASSEMBLY” filed on Feb. 23, 2014, the entire contents of which are incorporated herein by reference; and of U.S. Provisional Application No. 62/004,814, entitled “GAME CONTROLLER WITH LOCKING MECHANISM TO RECEIVE ENCASED PORTABLE COMPUTING DEVICE,” filed on May 29, 2014, the entire contents of which are incorporated herein by reference.

### BACKGROUND OF THE INVENTION

The present invention relates to video game controllers. More particularly, the present invention relates to a game controller for a portable computing device. Still more particularly, the present invention relates to a game controller with a locking mechanism to receive an encased portable computing device.

Video games have increased in popularity with users since their introduction in the 1970s. Presently there are thousands of different titled games as well as various different platforms upon which to play video games. Furthermore, the video games have gotten increasingly more sophisticated requiring many different user inputs. For example, a typical console game includes a game controller that has several different control inputs, several different trigger inputs and one or more joysticks that are used to interact with the video game.

In recent years, the use and popularity of smart phones or portable computing devices has also increased. These smart phones now include the ability to operate applications upon them and are now often used to play video games. However, unlike videogame controllers built for and connected to game consoles, smart phones often provide a limited number of input mechanisms. For example, most smart phones do not include a joystick type of input and are limited to a touch screen and one or two input buttons.

Another problem with using smart phones for playing video games is the consumption of power. Video games are often played for several minutes if not hours. When smart phones run video games for that amount of time, this consumes much of the battery life of the smart phone and can significantly impact the power available to the smart phone to before other types of operations.

Yet another problem with using smart phones to play video games is that they are optimized for portability in size and shape. That optimization in size and shape for portability by the user constantly, conflicts with the needs of the game controller different types of buttons, raised buttons, and other ergonomic features associated with the game controller.

Thus, there is a need for a mechanism to allow smart phones to be used more effectively for playing video games.

### SUMMARY OF THE INVENTION

The present invention is a game controller assembly. The game controller assembly is mechanically and communicatively connected to a user computing device to be used to play games. The game controller assembly is detachable he coupled mechanically and electrically to the user computing device. For example, the user computing device may be a smart mobile phone. The game controller assembly can be mounted on the smart mobile phone and also be communicatively coupled to the smart phone for communications with the smart phone. The game controller is used to play games on the smart phone. The game controller assembly can also be used for other purposes, such as navigating web pages, watching video streams, interacting with other online users, interacting/socializing, etc.

The game controller assembly is particularly advantageous. For example, there are some features, such as the design of shoulder buttons, which have benefits or purposes that suit particularly well a controller for a smart phone. For example, the controller includes two pairs of shoulder buttons that pivot on alternating axis. The back shoulder button pivots on a front-to-back axis, while the top shoulder button pivots 90° (ninety degree) on a left-to-right axis. This is a purposeful, custom design to solve a space-constraint problem and provide a better user experience. Other benefits are described below in the specification and will be apparent from review of the drawings.

According to one innovative aspect of the subject matter in this disclosure, a device for controlling and interacting with a video game operating on a computing device comprises a plurality of input devices for receiving user input; a connector for coupling to the computing device; a processor coupled to the plurality of input devices and the connector for receiving the user input from the plurality of input devices and communicating with the computing device; and a chassis defining an opening for removably holding the computing device, the opening sized to surround edges of the computing device leaving portions a top and a bottom of the computing device uncovered, the chassis housing the plurality of input devices, the connector and the processor, the connector coupling with the computing device when the computing device is positioned in the opening.

These and other implementations may each optionally include one or more of the following features. For example, features may include: wherein the computing device is secured in the opening of the chassis by a retaining lip, the retaining lip made of rubber silicon and positioned around the periphery of the opening such that the computing device can slide past the retaining lip into the opening for secure mounting inside the opening; wherein the plurality of input devices includes a pair of trigger buttons mounted on the side of the chassis, a first set of buttons on the top of the chassis, at least one joystick on mounted partially recessed in the chassis and cooperating with a first printed circuit board and a second printed circuit board to interface with the processor; wherein the plurality of input devices includes a first pair of trigger buttons mounted to rotate about a first axis of the chassis and a second pair of trigger buttons mounted to rotate about a second axis of the chassis, the first axis being substantially orthogonal to the second axis; wherein at least one of the plurality of input devices is a button for controlling social media interaction, the button controlling one from the group of audio capture, screen capture, video capture and voice integration; further comprising an output device for providing feedback to the user as to a status of social interaction; further comprising a data storage, the data storage housed in the chassis and coupled to the processor; wherein the chassis houses a battery, the battery coupled to the processor to provide power to the processor, and coupled to the connector to provide power to the computing device; and wherein the chassis forms an audio refraction channel from a speaker of the computing device to the surface of the chassis, the audio refraction providing sound amplification.

Other implementations of one or more of these aspects include corresponding systems, apparatus, and computer programs, configured to perform the actions of the methods, encoded on computer storage devices.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the subject matter disclosed herein.

### BRIEF DESCRIPTION OF THE DRAWINGS

The specification is illustrated by way of example, and not by way of limitation in the figures of the accompanying drawings wherein like reference numerals are used to refer to similar elements.

FIG. 1 is a high-level block diagram illustrating a first embodiment of a gaming system including a game controller assembly.

FIG. 2 is an exploded view of a first embodiment of the game controller assembly.

FIGS. 3A-3D show a top, side, bottom and perspective view, respectively, of the first embodiment of the game controller assembly.

FIG. 3E shows a right side view of the first embodiment of the game controller assembly including a user computing device illustrating a cutout of the game controller assembly accommodating audio and power connection of the user computing device.

FIG. 4A shows a top plan view of overlap of a prior art game controller holding a user device.

FIG. 4B shows a partial cross section view of the prior art game controller holding the user computing device.

FIG. 4C shows a top plan view of overlap of the first embodiment of the game controller assembly over the user computing device.

FIG. 4D shows a partial cross section view of the first embodiment of the game controller assembly over a user computing device.

FIG. 4E shows a partial cross section perspective view of the first embodiment of the game controller assembly over a user computing device.

FIG. 4F shows a foot print comparison of overlap.

FIG. 5 is a cross-section view of the first embodiment of game controller assembly taken along line 5/6-5/6 of FIG. 3A holding a first user computing device.

FIG. 6 is a cross-section view of the first embodiment of game controller assembly taken along line 5/6-5/6 of FIG. 3A holding a second user computing device.

FIG. 7 is perspective view, partially in section, of a first embodiment of a connector and the bottom chassis member of the game controller assembly.

FIG. 8 is perspective view, partially in section, of a second embodiment of a connector and the bottom chassis member of the game controller assembly.

FIG. 9 is a perspective view of the second embodiment of game controller assembly illustrating a port for charging the game controller assembly.

FIG. 10 is a flow diagram illustrating a method of power management for the game controller assembly and the user computing device according to one embodiment.

FIG. 11A is a top plan view of a third embodiment of the game controller assembly.

FIG. 11B shows a top view of a fourth embodiment of the game controller assembly.

FIG. 11C shows a perspective view of a fifth embodiment of the game controller assembly.

FIG. 11D shows a perspective view of a sixth embodiment of the game controller assembly.

FIG. 12A shows a bottom perspective view of a seventh embodiment of the game controller assembly.

FIG. 12B shows a bottom plan view of a seventh embodiment of the game controller assembly.

FIG. 12C shows a side view of a seventh embodiment of the game controller assembly.

FIG. 13A shows an exploded perspective view of an eighth embodiment of the game controller assembly, the user computing device and a case.

FIG. 13B shows a top plan view of the case, holding a user computing device that is used with the eighth embodiment of the game controller assembly.

FIG. 13C shows a cross-section view of the case taken along line 3C-3C of FIG. 3A.

FIG. 13D shows a bottom perspective view of the eighth embodiment of the game controller assembly.

FIG. 13E shows a sectional view a portion of the chassis of the eighth embodiment of the game controller assembly.

FIGS. 13F-13J show various embodiments for slots and their interaction with the case.

FIGS. 14A-14K show various embodiments for joysticks and joystick configurations.

FIGS. 15A-15C show various views of an embodiment for audio ducts created in the fourth embodiment of the game controller assembly.

FIGS. 16A and 16B show embodiments for the buttons and their interface with corresponding switches.

FIGS. 17A-D show perspective views of the eighth embodiment of the game controller assembly, partially in cross section to reveal the wring channel formed by the frame of the game controller assembly.

FIG. 18 is a perspective view of a mounting portion of at case system, in this example mounted on a bicycle frame.

FIG. 19 is a perspective view of a ninth embodiment of the game controller assembly adapted for social interactions.

### DETAILED DESCRIPTION OF THE PREFERRED EMBODIMENTS

A game controller assembly is described below. In the following description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, compact disc read-only memories (CD-ROMs), magnetic disks, read-only memories (ROMs), random access memories (RAMs), erasable programmable read-only memories (EPROMs), electrically erasable programmable read-only memories (EEPROMs), magnetic or optical cards, flash memories including universal serial bus (USB) keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

### System Overview

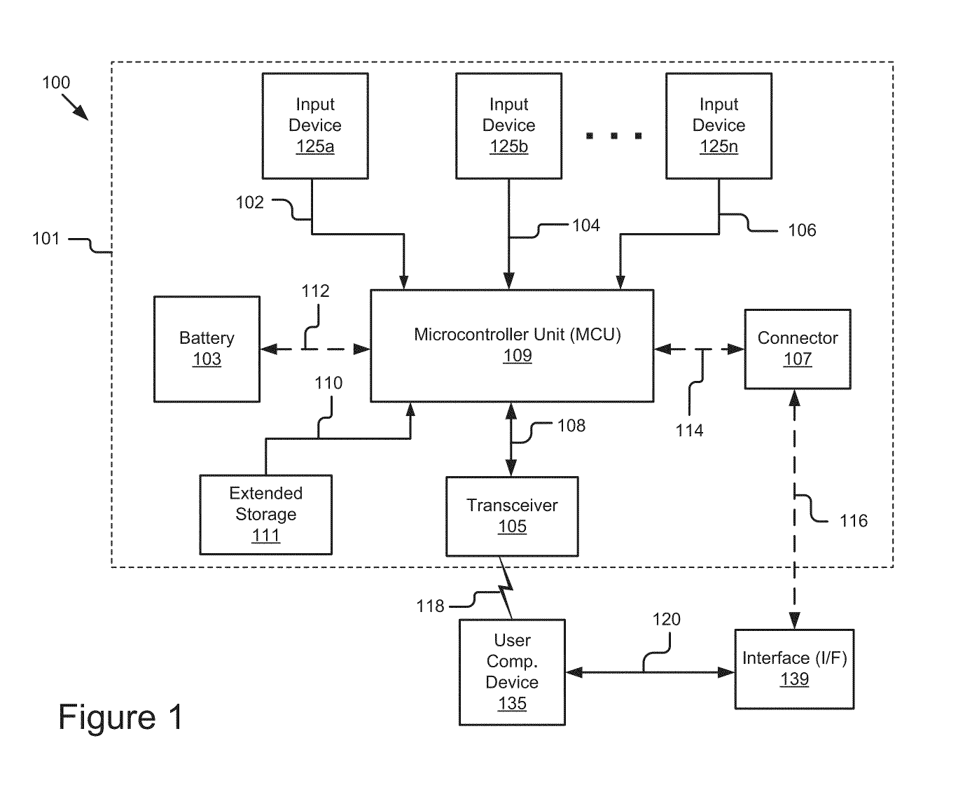

FIG. 1 illustrates a block diagram of a gaming system 100 including a game controller assembly 101 according to a first embodiment. The illustrated system 100 includes a game controller assembly 101, a user computing device 135 and an interface (I/F) 139. In the illustrated embodiment, the game controller assembly 101 includes one or more input devices 125a, 125b, 125n (referred to individually or collectively as input 125 device) that are from one or more users (not pictured), a microcontroller unit (MCU) 101, a transceiver 105, a battery 103, a connector 107 and extended storage 111.

The plurality of input 125 devices are provide to allow the user to input commands. Examples of the input devices 125 are further detailed below and in the remaining figures a may include various buttons, triggers buttons, toggle switches, push buttons, microphones, etc. Those skilled the art will recognize that these input devices as buttons are merely one embodiment for the plurality of input devices 125a, 125b, 125n and that various other configurations of fewer or more buttons or input devices are within the spirit and scope of the present embodiment of invention. More specifically, in another embodiment, game controller assembly 101 has a minimum number of) buttons.

In the illustrated embodiment, the game controller assembly 101 is communicatively coupled to the user computing device 135 via the connector 107 and the interface (I/F) 139 along signal lines 114, 116 and 120, or wirelessly via the transceiver 105 and signal line 108. In the illustrated embodiment, the game controller assembly 101 receives inputs from users using the input devices 125 via signal lines 102, 104 and 106.

Although only one MCU 109, one battery 103, one connector 107 and one transceiver 105 are illustrated in FIG. 1, it should be recognized that any number of MCUs 109, batteries 103, connectors 107 and transceivers 105 can be included in the game controller assembly 101. Furthermore, while only one user computing device 135 and one interface (I/F) 139 are coupled to the game controller assembly 101, it should be appreciated that any number of user devices 135 and interfaces 139 can be connected to the game controller assembly 101.

The microcontroller unit (MCU) 109 is any computing device on a single integrated circuit including a processor, memory and programmable input/output (I/O) interfaces. The processor may comprise an arithmetic logic unit, a microprocessor, a general purpose controller or some other processor array to perform computations, retrieve data stored on a storage device, etc. The processor processes data signals and may comprise various computing architectures including a complex instruction set computer (CISC) architecture, a reduced instruction set computer (RISC) architecture, or an architecture implementing a combination of instruction sets. In one embodiment, the processing capability of the processor may be limited to supporting the display of signals and the capture and transmission of signals. In another embodiment, the processing capability of the processor might be enough to perform more complex tasks, including various types of feature extraction and sampling. It will be obvious to one skilled in the art that other processors, operating systems, sensors, displays and physical configurations are possible.

In one embodiment, the memory stores instructions or data that may be executed by the processor. The instructions or data may include code for performing video game playing techniques. The memory may be a dynamic random access memory (DRAM) device, a static random access memory (SRAM) device, flash memory or some other memory device. In one embodiment, the memory also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In one embodiment, the MCU 109 receives input signals from users via the input devices 125, processes the input signals and transmits the processed input signals to the user computing device 135 for facilitating the users to play video games on the user computing device 135. For example, when a user pushes a direction button (e.g., left direction button) 125, the MCU 109 receives a signal indicating that the user pushed the direction button. The MCU 109 processes the signal and sends the processed signal to the user computing device 135 via the transceiver 105 so that the user computing device 135 displays a corresponding result in the video game (e.g., the character that the user plays in the video game moves left).

The transceiver 105 is any computing device that transmits and receives signals for the MCU 109. In one embodiment, the transceiver 105 is implemented using hardware such as field-programmable gate array (FPGA) or an application-specific integrated circuit (ASIC). In another embodiment, the transceiver 105 is implemented using a combination of hardware and software. In one embodiment, the transceiver 105 may be applicable to a network. The network may be a conventional type, wired or wireless, and may have any number of configurations such as a star configuration, token ring configuration or other configurations known to those skilled in the art. Furthermore, the network may comprise a local area network (LAN), a wide area network (WAN) (e.g., the Internet), and/or any other interconnected data path across which multiple devices may communicate. In yet another embodiment, the network may be a peer-to-peer network. The network may also be coupled to or include portions of a telecommunications network for sending data in a variety of different communication protocols. In one embodiment, the network is a Bluetooth communication network. For example, the transceiver 105 communicates with the user computing device 135 via a low power Bluetooth channel. In another embodiment, the network includes a 3G network, a 4G network, a Wi-Fi network or a cellular communications network for sending and receiving data such as via short messaging service (SMS), multimedia messaging service (MMS), hypertext transfer protocol (HTTP), direct data connection, WAP, e-mail, etc. In yet another embodiment, all or some of the links in the network are encrypted using conventional encryption technologies such as secure sockets layer (SSL), secure HTTP and/or virtual private networks (VPNs).

In one embodiment, the transceiver 105 includes an antenna to facilitate the communications via the network between the MCU 109 and the user computing device 135. The antenna may be an electrical device that converts electric currents into radio waves, and vice versa. For example, the antenna is a steerable beam directional antenna. In one embodiment, the antenna receives signals from the MCU via the network and sends the received signals to one or more other components of the transceiver 105 for processing. The transceiver 105 then delivers the processed signals to the MCU 109. In another embodiment, the antenna receives signals from one or more other components of the transceiver 105 and delivers the signals to the user computing device 135 via a network, e.g., a Bluetooth network.

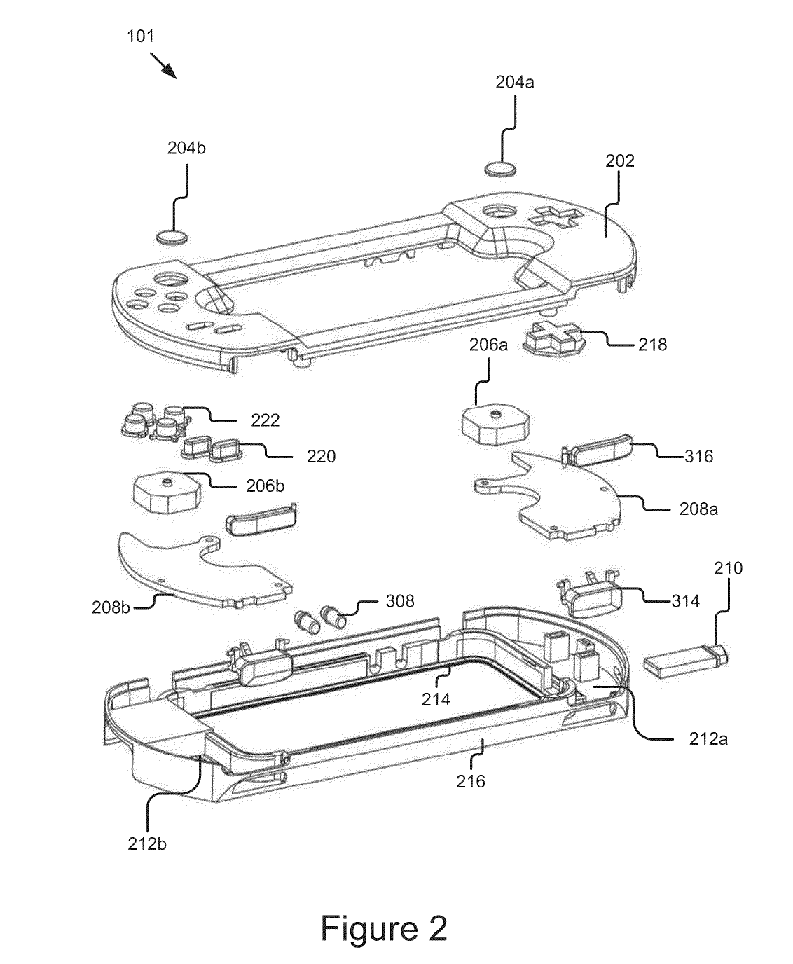

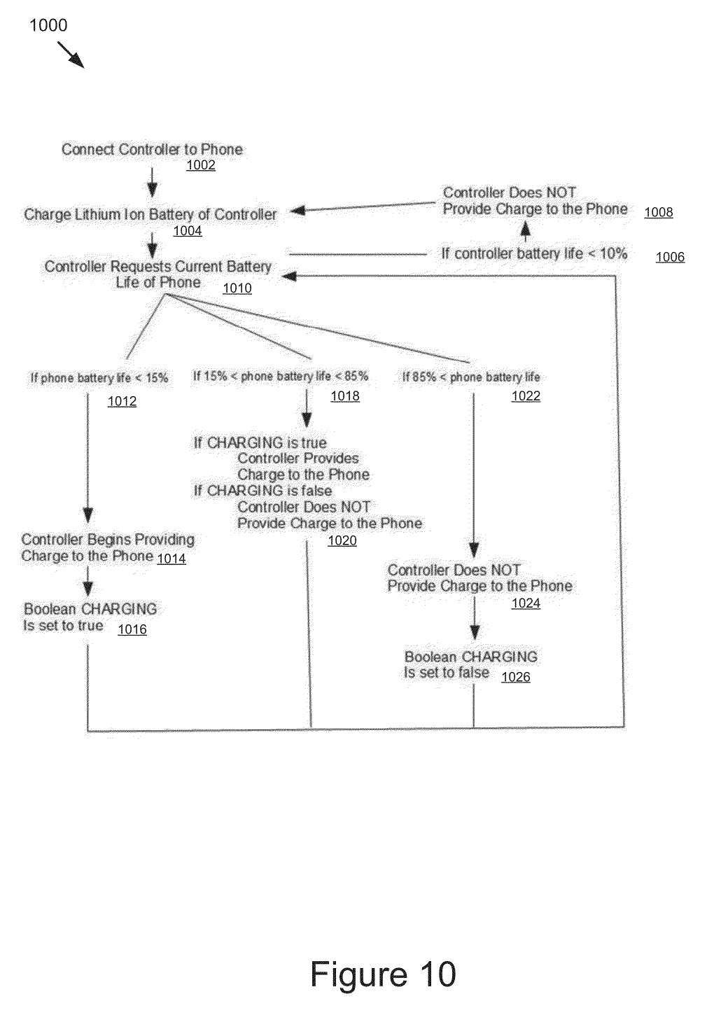

The battery 103 is any battery device applicable to the MCU 109. In one embodiment, the battery 103 is an external battery. For example, the battery 103 may be a tiny battery similar to those used for a watch. In one embodiment, the battery 103 is embedded into chassis members of the game controller assembly 101, which will be described with reference to FIG. 2. In one embodiment, the battery 103 is connected to the user computing device 135 to facilitate powering the user computing device 135. For example, the battery 103 may be integrated with the user computing device 135 so that the battery 103 can supply power for both the game controller 101 and the user computing device 135 when necessary. In one embodiment, the battery 103 is rechargeable. For example, when charging the battery 103, if some condition has been met, the controller 101 also provides charging to the user computing device's battery. This power management will be described in further detail with reference to FIG. 10.

High grade video games take substantially more processing power and electrical energy to perform adequately on mobile devices and thus extending the battery life of the user computing device 135 is particularly advantageous. The present invention adds a battery 103 to the game controller assembly 101 in order to solve this problem. This will extend the battery life of the user computing device 135 so long as this game controller assembly 101 is in place irrespective of the user computing device 135 having been inserted into the game controller assembly 101. The game controller assembly 101 thus serves as a useful function for the user computing device 135 independent of the game controller assembly 101 itself. This battery 103 will be charged using an AC/DC to mini-USB plug and will either manually or automatically provide extra energy as needed.

If the battery 103 on the game controller assembly 101 is controlled manually, there will be a switch or button on the game controller assembly 101 which will allow the user to toggle the battery 103 on or off. This will allow the user to have the game controller assembly's 101 battery 103 provide extra power to the user computing device 135 during extended gaming sessions or in other instances when extended battery life of computing device 135 is desirable. The battery 103 can be toggled off to conserve this extra potential when it is not required. If the battery 103 on the game controller assembly 101 is controlled automatically, then the game controller assembly 101 will plug into the user computing device 135 via the lightning connector 107 and over this wired connection monitor the current battery 103 life of the user computing device 135.

If the energy in the battery of the user computing device 135 depreciates past a certain amount, the battery 103 on the game controller assembly 101 will automatically provide extra power to the user computing device 135 until the user computing device's 135 battery no longer requires extra charge. No matter which of these two methods used to extend the battery life of the user computing device 135, both will increase the utility of our the game controller assembly 101 as a gaming assembly. If the game controller assembly 101 is being used with a tablet or other wireless connected device a battery 103 block that clips into the controller in place of a smart mobile device could be used to significantly increase the battery 103 life of the controller device. This battery 103 would also serve both aesthetic and functional value by filling in the gap in the controller device where the smart mobile phone would otherwise be.

In one embodiment, optionally the MCU 109 is connected to the interface (I/F) 139 of the user computing device 135 via the connector 107. In one embodiment, the MCU 109 obtains power through this connection to the user computing device 135.

In one embodiment, the game controller assembly 101 also includes extended storage 111. The extended storage device 111 may be a non-transitory memory that stores data. For example, the storage device is a dynamic random access memory (DRAM) device, a static random access memory (SRAM) device, flash memory or some other memory device known in the art. In one embodiment, the storage device also includes a non-volatile memory or similar permanent storage device and media such as a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device known in the art. The game controller assembly 101 can also be outfitted with nonvolatile data storage that can augment the user computing device's 135 internal storage. This nonvolatile storage can provide storage for any sort of data desired, including pictures, music, videos and movies, textual data, applications, or any other digital data, and is persisted through time using one of various long-term digital storage methods. The nonvolatile storage could be made available to the user computing device 135 through any number of strategies, such as a file system, a server, or some other strategy. This feature is especially advantageous due to a correlation between large resources and resources that will be needed only while using the game controller assembly 101, such as the data representing a video game application. For example, one possibility would be to embed a typical NAND Flash storage device in the game controller assembly 101. The Flash storage could be made available to the connected device, the user computing device 135, via USB interface. The user would have the option to designate gaming applications for storage on the controller Flash storage instead of the user computing device's 135 internal storage, thereby freeing the user computing device's 135 internal storage for additional music, pictures, or other data.

The user computing device 135 may be a portable computing device that includes a memory and a processor, for example a tablet computer, a mobile telephone, a smart phone, a personal digital assistant (“PDA”), a mobile email device, a portable game player, a portable music player with one or more processors embedded therein or coupled thereto or other electronic device capable of accessing a network. For example, the user computing device 135 may be an iPhone or iPhone 5 manufactured and sold by Apple Computer, Inc. of Cupertino, Calif. In one embodiment, the user computing device 135 includes a browser for accessing online services. In one embodiment, the user computing device 135 includes one or more apps or applications for playing games.

In some embodiments, the user computing device 135 may include a software support application for cooperation and interaction with the game controller assembly 101. User selected or software controlled preferences or settings will be referred to multiple times throughout this document. One method for achieving this functionality is to create a partner support application to be used by the user computing device 135 which give the user the capability to tune the game controller assembly 101 to his or her personal preference. Settings that might take advantage of such an application include but are not limited to, battery charging preferences, voice communication settings, social media button functions, and local wireless network set-up or connections. This application is not essential to the game controller assembly 101, but it allows for a particularly advantageous embodiment that provides the best possible user experience.

In the illustrated embodiment, the user computing device 135 is communicatively coupled to the game controller assembly 101 through the transceiver 105 via signal line 118 (wirelessly). In one embodiment, signal line 118 is any combination of wireless communication channels such as one or more of a BLUETOOTH, Wi-Fi, 3G, 4G, GPS or any other suitable wireless network communication channel. In the illustrated embodiment, the user computing device 135 is also communicatively connected to an interface (I/F) 139 via signal line 120. In another embodiment, the interface (I/F) 139 is embedded or included by one or more other ways in the user computing device 135. In one embodiment, the interface 139 is a device configured to handle communications and/or power transmission between the game controller assembly 101 and the user computing device 135. Optionally, in one embodiment, the interface (I/F) 139 is communicatively coupled to the game controller assembly 101 through the connector 107 via signal line 116. For example, in one embodiment, the MCU 109 is coupled to the user computing device 135 through signal line 114, the connector 107 and the interface 139 (I/F) for power transmission.

In one embodiment of the game controller assembly 101, it may allow for two different modes of communication between the MCU 109 and other devices: a wired connection via connector 107 and interface 139 or a wireless connection via transceiver using any of several communication protocols. The user could toggle between these two modes of communication as needed by adjusting a toggle switch (not shown) on the game controller assembly 101. This would allow users to connect to the user computing device 135 enmeshed within the game controller assembly 101 through a wired or wireless connection, but also more importantly allow game controller assembly 101 to connect wirelessly to external devices such as a tablet or personal computer in addition to the user computing device 135. This gives the game controller assembly 101 the potential to act as a controller for a wide range of gaming devices, increasing its utility as a controller across multiple platforms. The wired connection would also allow for faster, more energy efficient communication between an enmeshed the user computing device 135 and the game controller assembly 101 while the wireless connection still allows for communication between the game controller assembly 101 and other external devices (not shown). Though one or the other mode of communication would suffice for use of the game controller assembly 101 with the user computing device 135, the flexibility of providing both is particularly advantageous in allowing the game controller assembly 101 to be used on a much wider range of devices for either gaming or hobby purposes while also preserving the higher speed, more stable and more efficient connection that is of particular concern to the mobile gaming community.

The communication between the connected device (the user computing device 135) and the MCU 109 is a bidirectional data conduit allowing application developers who enable support of the MCU 109 to send commands and data back to the MCU 109 as well as receiving information about the state of the MCU 109. This allows the MCU 109 to provide additional channels of feedback from the application to the user. Special illumination, tactile feedback, or audible feedback via speakers are all examples of this feedback. One specific example would be a system by which a game application running on the user computing device 135, in this case a smart mobile phone, could send a message by a defined software protocol requesting the MCU 109 to activate a vibration transducer. This transducer could produce physical motion of as specified by the MCU 109 in synchronization with an event in the game, enhancing the game experience.

### Mechanical Structures

Referring now to FIG. 2, depicted is an exploded view of a first embodiment of the game controller assembly 101. It should be understood that for various following figures, similar reference numbers are used to refer to similar components that have the same or similar functionality. The game controller assembly 101 comprises a top chassis member 202, upper portions of joysticks 204, lower portions of joysticks 206, circuit boards 208, a plunger button, cavities 212, a retaining lip 214, a bottom chassis member 216, a directional pad or control pad 218, a second set of buttons 220 and third set of buttons 222. For example, the mechanical structure of the game controller assembly 101 may be provided the same as or similar function as traditional game controller but with different mechanical structure, features and operation, most significantly being the cooperation with the user computing device 135.

The game controller assembly 101 includes the top chassis member 202 (or faceplate) that mates with the bottom chassis member 216 (or shell) to form the exterior housing of the game controller assembly 101. In some embodiments, the top chassis member 202 is overlaid on top of the user computing device 135 or phone. This design is particularly advantageous because it allows buttons to be placed nearer to the screen, allowing the user to switch quickly between the control buttons and touching the phone screen. By placing the top chassis member 202 over the phone, it also allows us to reduce the overall size of the game controller assembly 101. The top chassis member 202 defines holes for receiving the upper portions of joysticks 204a, 204b, the directional pad 218, the second set of buttons 220, and the third set of buttons 222. The upper portions of joysticks 204a, 204b are above the face of the top chassis member 202 and positioned proximate one side of the game controller assembly 101. Each joystick 204a, 204b is positioned proximate opposite corners of the user computing device 135 but along the same side. Near one of the joysticks 204b, the third set of buttons 222 arranged in a cross configuration. The second set of buttons 220 are also located near the same end as joystick 204b. The lower portions of joysticks 206a, 206b mate with and support the upper portions of joysticks 204a, 204b inside the game controller assembly 101. The lower portions of joysticks 206a, 206b are below the face of the top chassis 202. The circuits 208a, 208b are sandwiched between the top chassis member 202 in the bottom chassis member 216. Although not shown in FIG. 2, the circuits 208a, 208b may be printed circuit boards (PCBs) and may be coupled by a ribbon cable housed within the game controller assembly 101. In order to have the controller chassis overlay on top of the user computing device 135, the circuits 208a, 208b are located above the height of the user computing device 135 in cavities 212a, 212b defined by the top chassis member 202 and the bottom chassis member 216. When the top chassis member 202 and the bottom chassis member 216 are mated together, they define holes for receiving and holding buttons 308 in mechanical contact with corresponding buttons on the user computing device 135. These buttons 308 provide mechanical translation so that control buttons on the user computing device 135 can still be activated by depressing them. The game controller assembly 101 also houses the plunger button 210. The plunger button 210 is for activating a button on the user computing device 135. The plunger button 210 extends through the bottom chassis 216 of the controller assembly. As can be seen from the exploded view, when assembled together the top chassis member 202 and the bottom chassis member 216 form cavities 212a, 212b. These cavities 212a, 212b can accommodate one or more batteries and/or one or more antennas. The bottom chassis member 216 defines a rectangular area for receiving the user computing device 135. Around the periphery of this rectangular area, the bottom chassis member provides a retaining lip 214 for securing the user computing device 135 within the rectangular area. In one embodiment, the retaining lip 214 can be made of rubber silicon or any other suitable rubber so that a user computing device 135 can slide into the game controller assembly 101 and be held in the by the lip 214 after being slid in. The top chassis member 202 and the bottom chassis member 216 when mounted together from a single chassis that defines an opening 302, 312 for removably holding the user computing device 135. The opening 302, 312 is sized to surround the edges of the user computing device 135 leaving portions the top and bottom of the user computing device 135 uncovered, the chassis housing the plurality of input devices 125 (buttons, joystick, etc.), the connector 107 and the MCU 109.

Referring now to 3A-3E, additional views of the first embodiment of the game controller assembly 101 and particular features will be described.

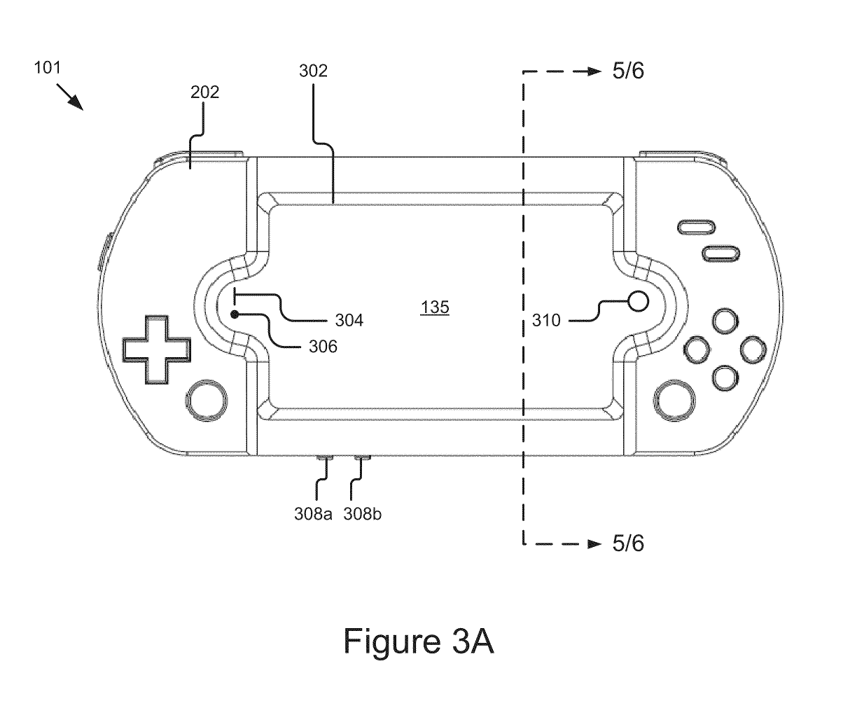

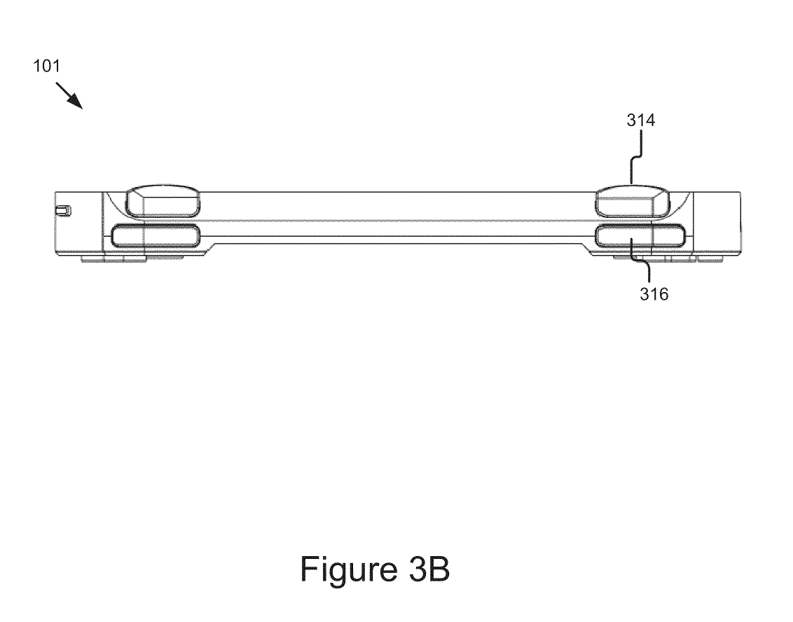

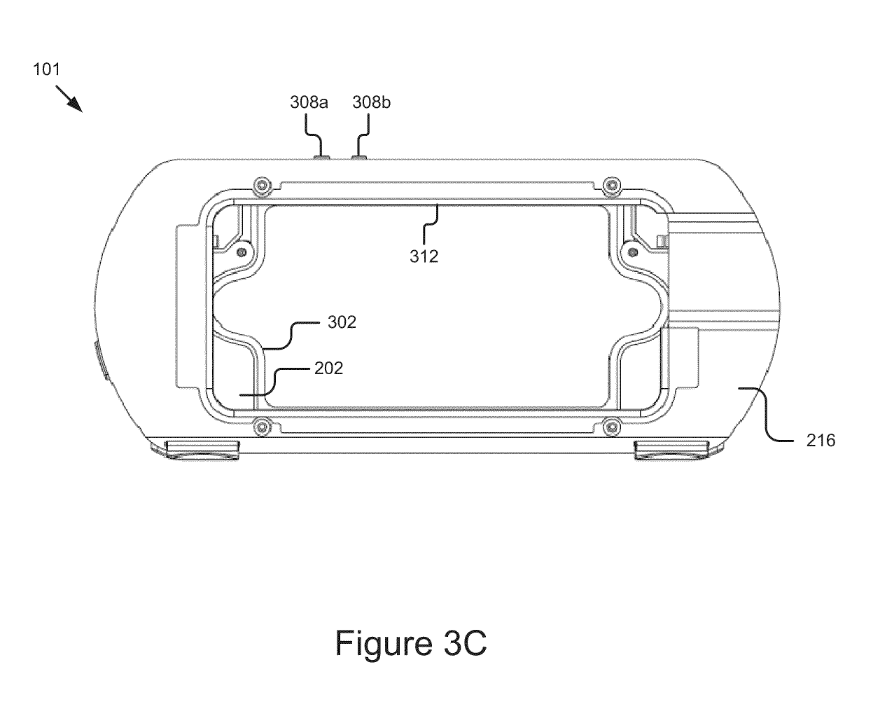

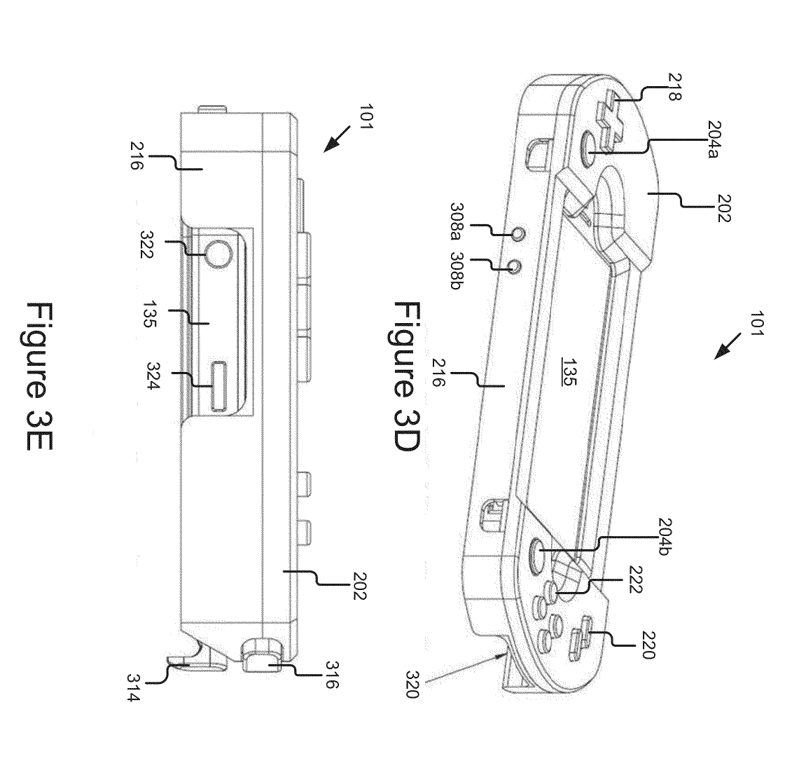

FIG. 3A shows a top plan view of the first embodiment of the game controller assembly 101 holding a user computing device 135. FIG. 3A shows how the buttons are available to the user proximate opposite ends of the game controller assembly 101. FIG. 3A also shows an opening 302 defined by the top chassis member 202 that makes the screen of the user computing device 135 completely viewable. The opening 302 also has semicircular cutouts proximate the opposite ends for exposing the speaker 304 and camera 306 of the user computing device 135. The opening 302 also has a cut out to fully expose a home button 310 of the user computing device 135. It should be understood that the opening 302 is merely one example, and that various other shapes for the opening could be used to match the positioning of these elements on the user computing device 135. FIG. 3A also shows buttons 308a, 308b for volume control of the user computing device 135. These buttons 308a, 308b when depressed, provide mechanical translation of that input to the volume buttons on the user computing device.

FIG. 3B shows a back side view of the first embodiment of the game controller assembly 101. FIG. 3B shows the relative positions and shapes for the side buttons 314, 316. As can be seen, their corresponding left and right pairs of side buttons 314 and 316. The buttons 314, 316 are positioned proximate the ends of the game controller assembly 101 so that they can be easily manipulated by the index finger of the user. The buttons 314, 316 can be bumper buttons.

FIG. 3C shows a bottom view of the first embodiment of the game controller assembly 101. In this Figure, no user computing device 135 is inserted into the opening defined by the top chassis member 202 and the bottom chassis member 216. As can be seen, the opening 302 defined by the top chassis member 202 is smaller than the opening 312 defined by the bottom chassis member 216.

FIG. 3D shows a perspective view of the first embodiment of the game controller assembly 101. This perspective view shows a cutout or slot 320 defined when the top chassis member 202 and the bottom chassis member 216 are assembled together. Referring also to FIG. 3E, which shows a right side view of the first embodiment of the game controller assembly 101 housing a user computing device 135, is can be seen how the cutout or slot 320 exposes a portion of the user computing device 135, in particular, the audio connector 322 (speaker jack) and power connector 324.

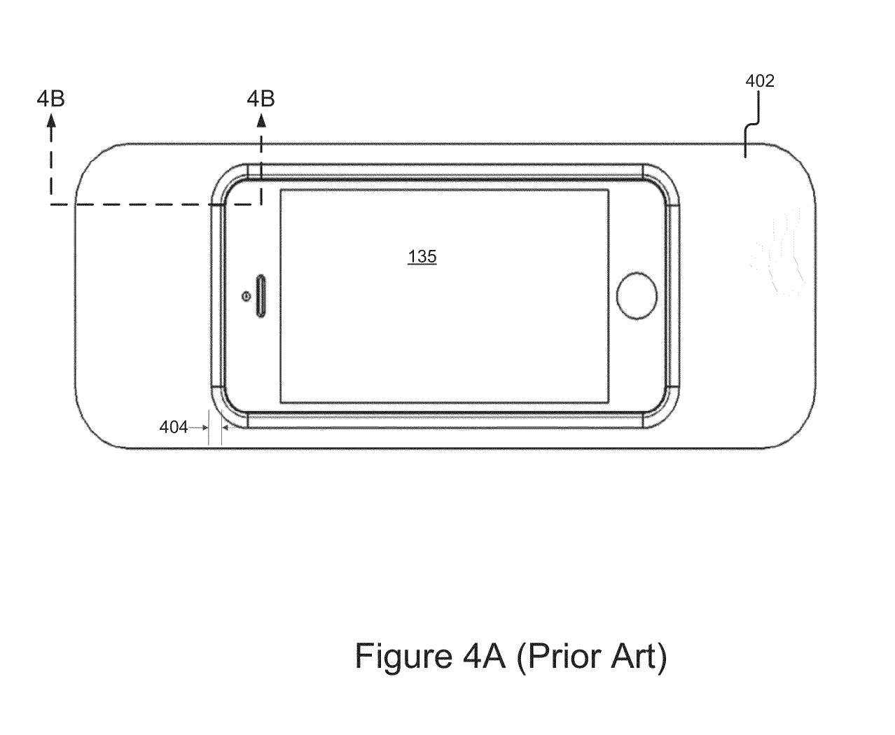

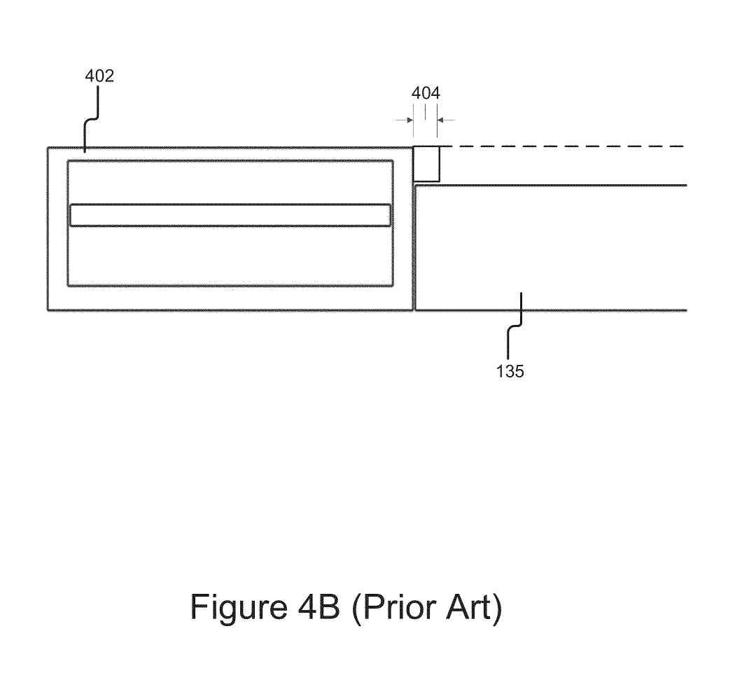

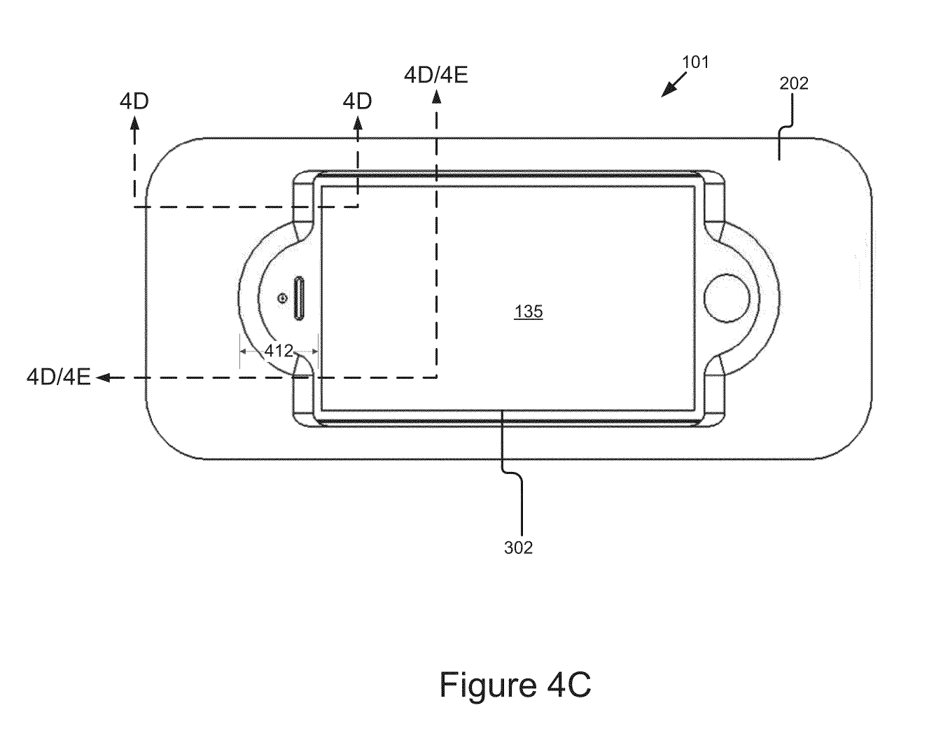

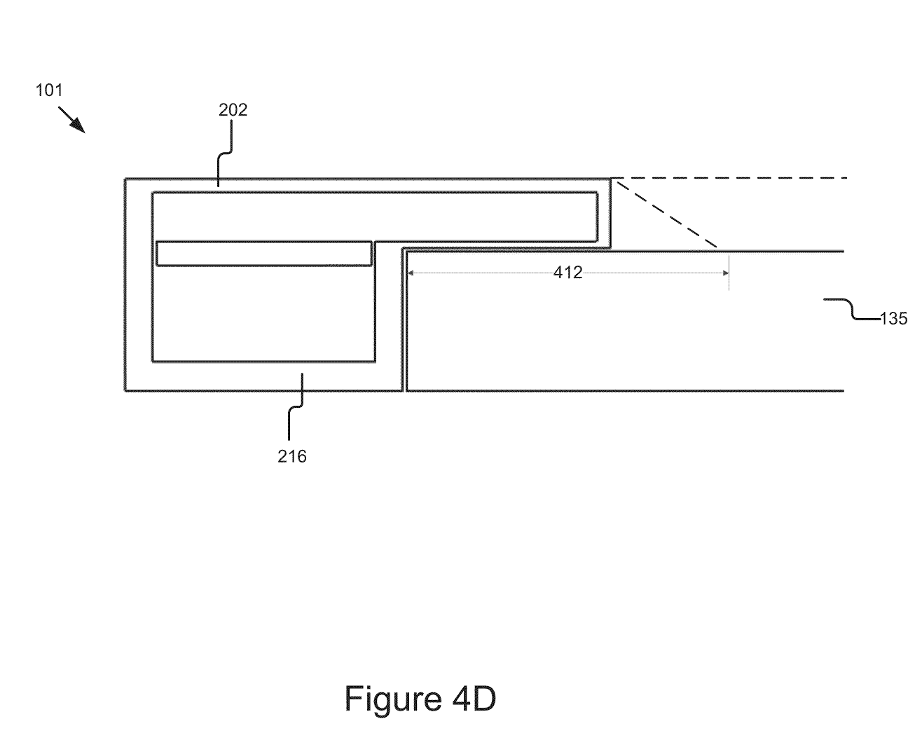

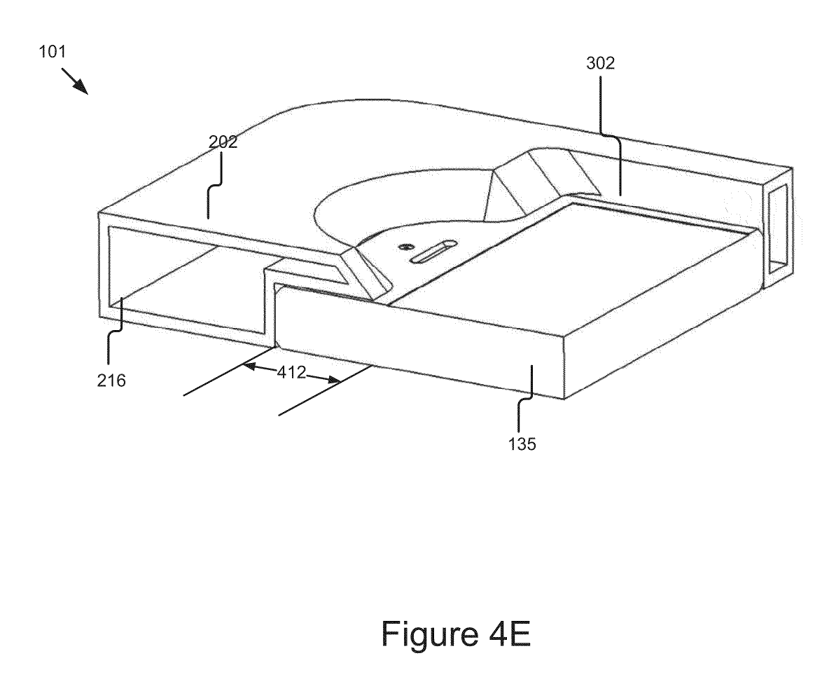

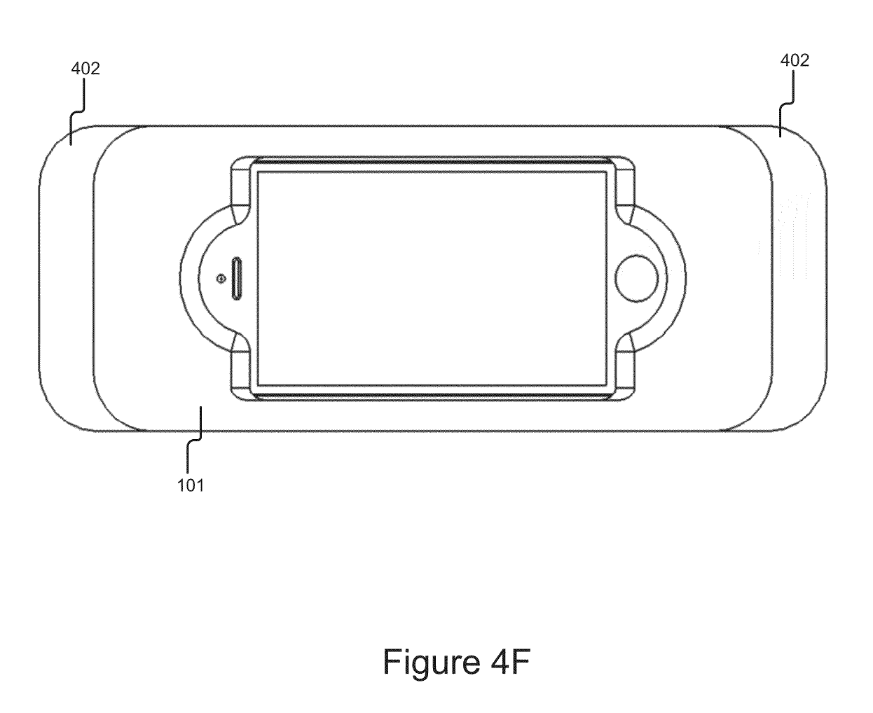

FIG. 4A shows a top plan view of overlap 404 of a prior art game controller 402 holding the user computing device 135. As can be seen, there is little if any overlap 404 between the game controller 402 and the top or the bottom of the user computing device 135. Thus, the user computing device 135 is not held securely in the prior art game controller 402. FIG. 4B shows a partial cross section view of the prior art game controller 402 holding the user computing device 135 taken along line 4B-4B of FIG. 4A. This shows that the only thing holding the user computing device 135 in the prior art game controller 402 is friction between the user computing device 135 the prior art game controller 402.

In contrast as show in FIG. 4C, the overlap 412 of the first embodiment of the game controller assembly 101 over a user computing device 135 is substantial. This prevents the user computing device 135 from moving and holds it securely in the game controller assembly 101. FIG. 4D shows a partial cross section view of the first embodiment of the game controller assembly 101 over the user computing device 135 taken along line 4D-4D of FIG. 4C. FIG. 4D shows how the game controller assembly 101 overlays on top of the user computing device 135, and functional components of game controller assembly 101 such as buttons and joystick overlay with the surface of the user computing device 135. As can be seen, even along the side walls of game controller assembly 101, there is substantial overlap 412. The overlapping design of this embodiment of the game controller assembly 101 is advantageous because it minimizes the total envelope. A small envelope is advantageous for mobile devices because the game controller assembly 101 will have to be portable and ideally-suited for carrying on one's person in a bag or pocket. The overlaps allows for a decrease in the length of the chassis which also allows the hands and fingers to be closer to user computing device 135 when the game controller assembly 101 is in use. This is advantageous for being able to interact with the screen while also using the game controller assembly 101, either for typing messages, or game controls, or other phone functions. FIG. 4E shows a partial cross section perspective view of the first embodiment of the game controller assembly 101 over a user computing device 135 taken along line 4E-4E of FIG. 4C. As can be seen, in the corners of opening 320 the overlap is even more pronounced. FIG. 4F shows a foot print comparison of overlap of the controller 101 of the present invention overlaid on the controller 402 of the prior art. As can be seen, the controller 101 of the present invention yields a significant reduction in overall foot print. Thus, it provides all the functionality of a game controller without a significant increase in the size of the user computing device 135.

The cutouts on the overlap preserve the user computing device 135 features that are on the front side of user computing device 135. The front microphone, camera, speaker, and home button are accessible because the cutouts allow the user to interact with aforementioned features. The overlapping design of the game controller assembly 101 also extends benefits to user computing device 135 protection. The user computing device 135 now has more of its surface covered by the game controller assembly 101 body. This will protect the user computing device 135 and its screen if the user computing device 135 is set down improperly or is dropped.

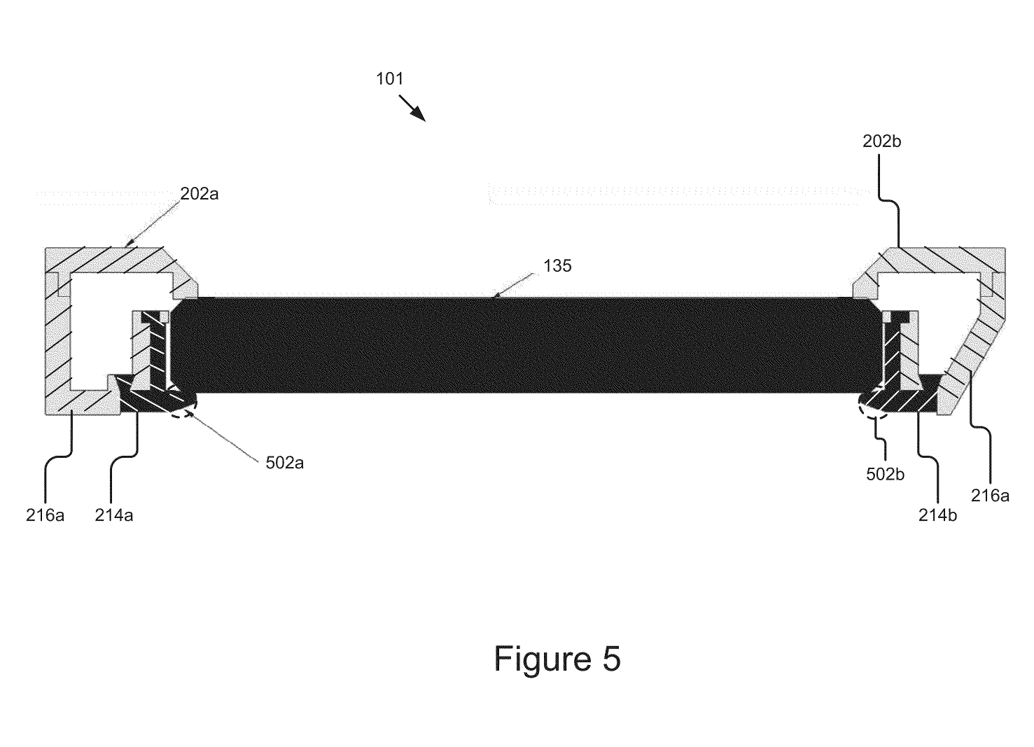

FIG. 5 is a cross-section view of the first embodiment of game controller assembly 101 taken along line 5/6-5/6 of FIG. 3A holding the user computing device 135. As can be seen, the top chassis member 202a, 202b and the bottom chassis member 216a, 216b mate together to form the game controller assembly 101. FIG. 5 shows the retaining lips 214a, 214b of the game controller assembly 101 in more detail and shaded darker in the figure. For example, the retaining lips 214a, 214b are made of rubber silicon or any other suitable rubber so that the user computing device 135 can slide into the game controller assembly 101 and be retained after being slid in. In some embodiments, a corrugated rubber design is used to snugly hold a range of sizes of user computing devices. Inside the cavity where the user computing device 135 will be held, there is an inlay of a corrugated rubber. This inlay may take the shape of a series of ridges that fold when a user computing device 135 is inserted into the game controller assembly 101. The inlay ensures that the appropriate amount of pressure is placed on the user computing device 135 in order to hold it and secure it in place. The retaining lips 214a, 214b may include members that extend toward the opening to server as retaining feet 502a, 502b. For example, the retaining feet 502a, 502b may be soft silicon so that the user computing device 135 can easily slide into the game controller assembly 101.

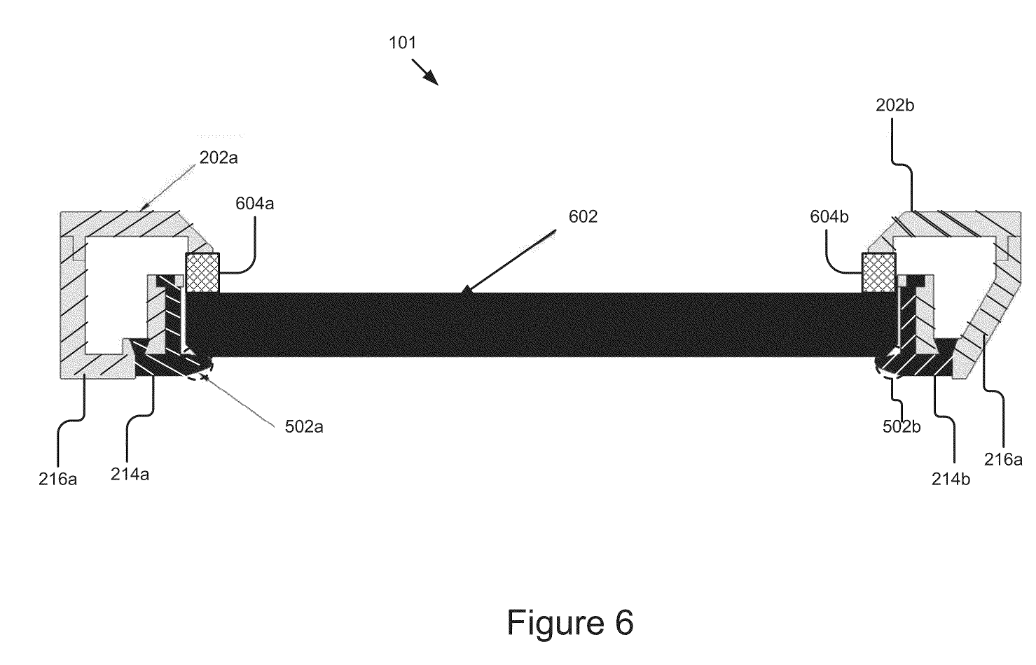

FIG. 6 is a cross-section view of the first embodiment of game controller assembly 101 taken along line 5/6-5/6 of FIG. 3A holding a second user computing device 602. In the illustrated embodiment, the second user computing device 602 has a different form factor than the user computing device 135 and is a portable music playing device, e.g., an iPod. Again similar to FIG. 5, the top chassis member 202a, 202b and the bottom chassis member 216a, 216b mate together to form the game controller assembly 101. Similarly, the retaining lips 214a, 214b are attached to the bottom chassis member 216a, 216b near the interior bottom and extend peripherally inward. The retaining lips 214a, 214b include members that extend toward the opening to server as retaining feet 502a, 502b. This embodiment also includes adaptors 604a, 604b for accommodating thinner user devices 602, e.g., iPods. In one embodiment, the adaptor 604a, 604b may be a grommet. For example, the adaptor 604a, 604b is a rubber ring for securing the thinner user computing device 602 in place. In some examples, the adaptor 604a, 604b is shaped to match the size and shape of the opening 302 defined by the top chassis member and the vertical wall of the retaining lips 214a, 214b. The adaptors 604a, 604b can be provided in various thickness to work with various different devices. In other examples, the adaptor 604a, 604b can be of any shape, e.g., oval.

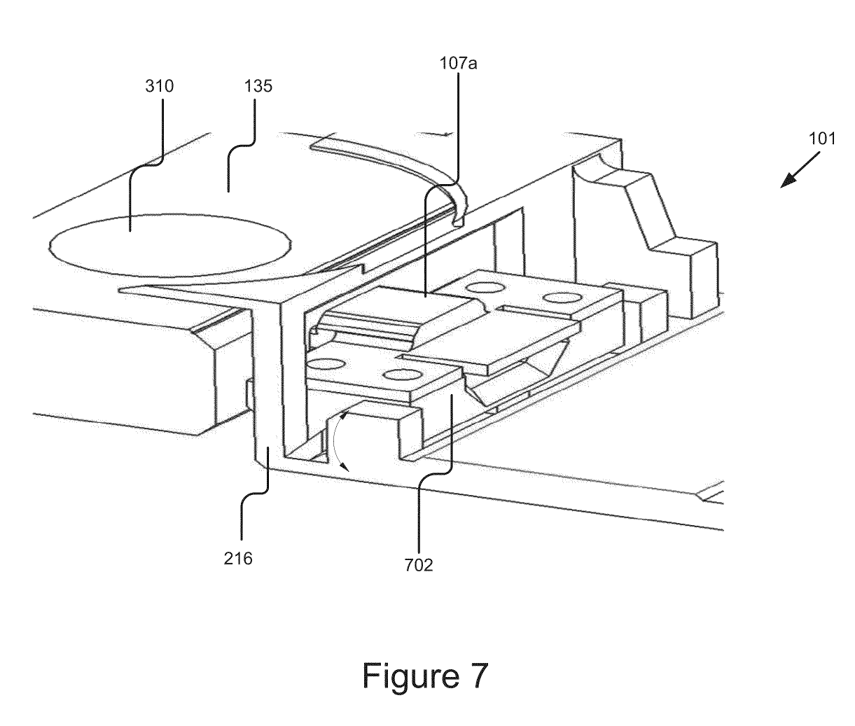

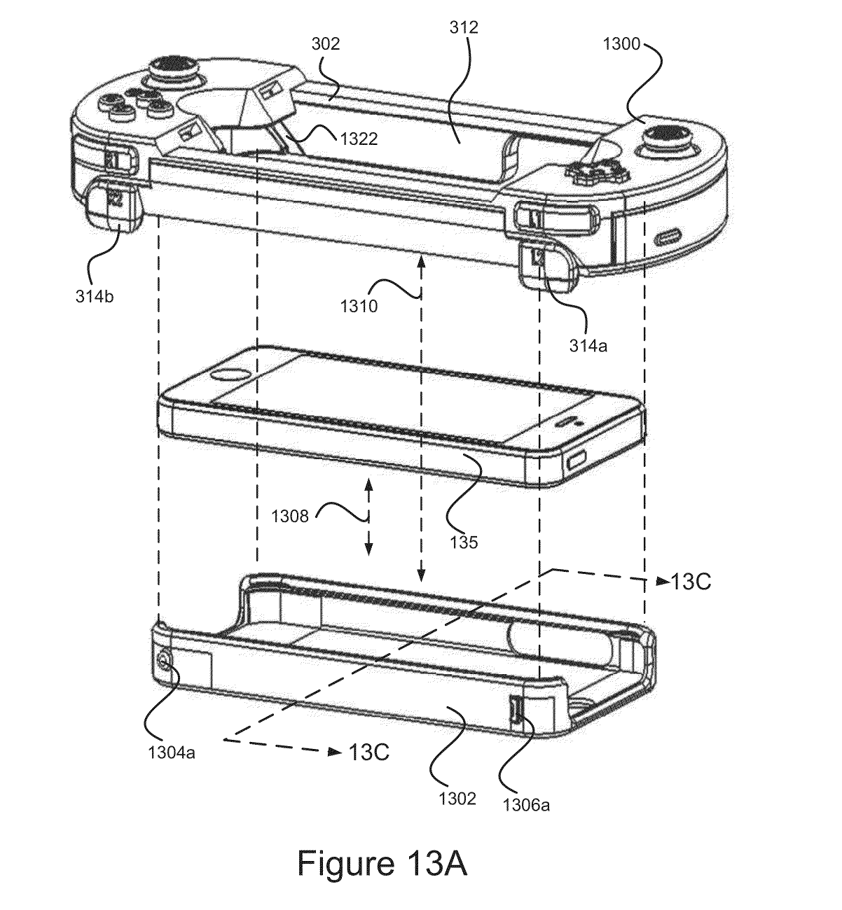

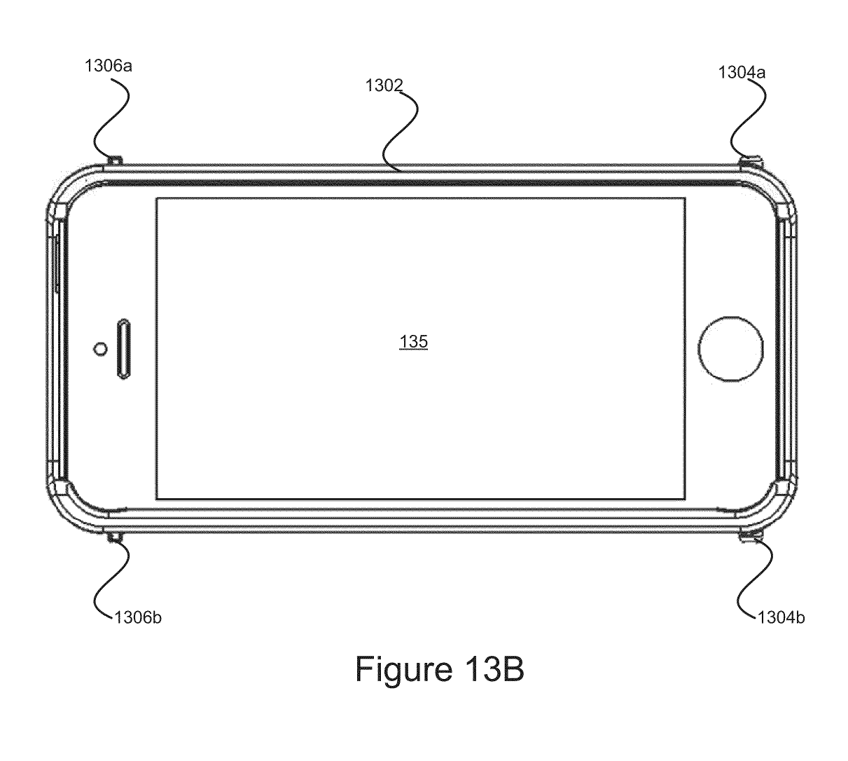

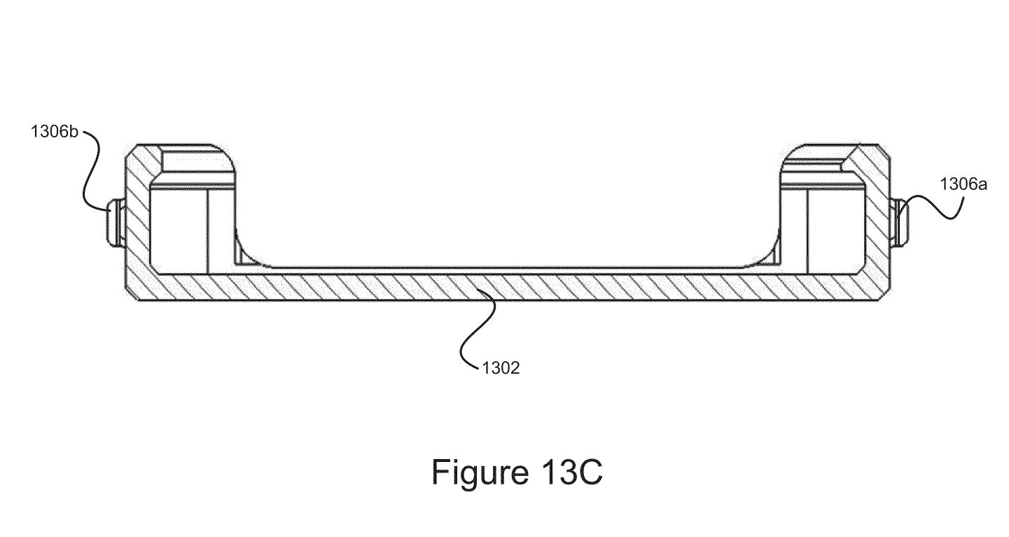

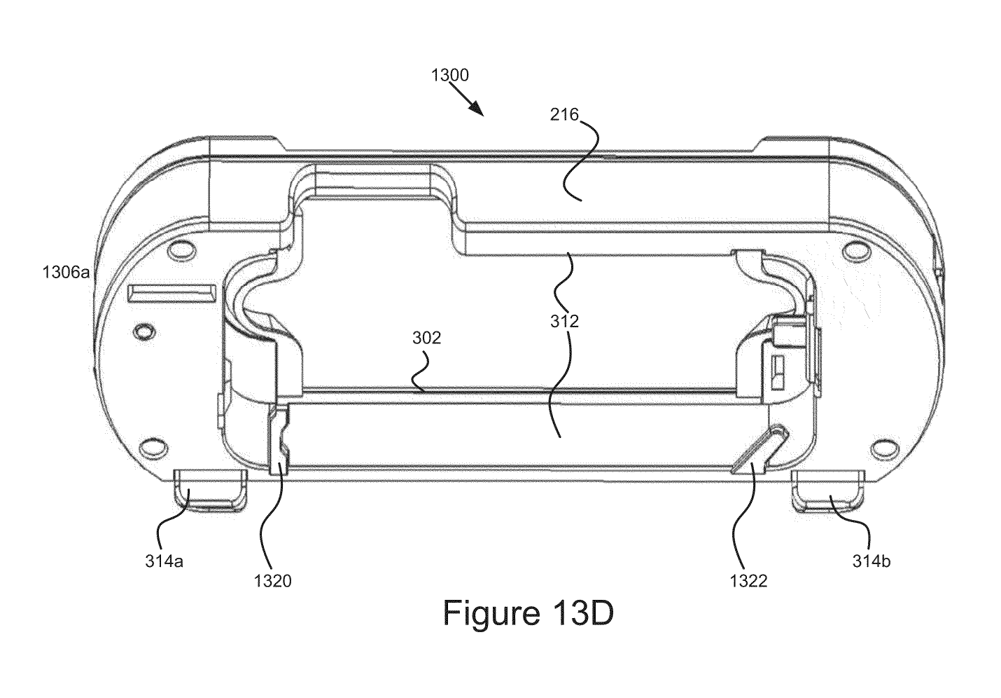

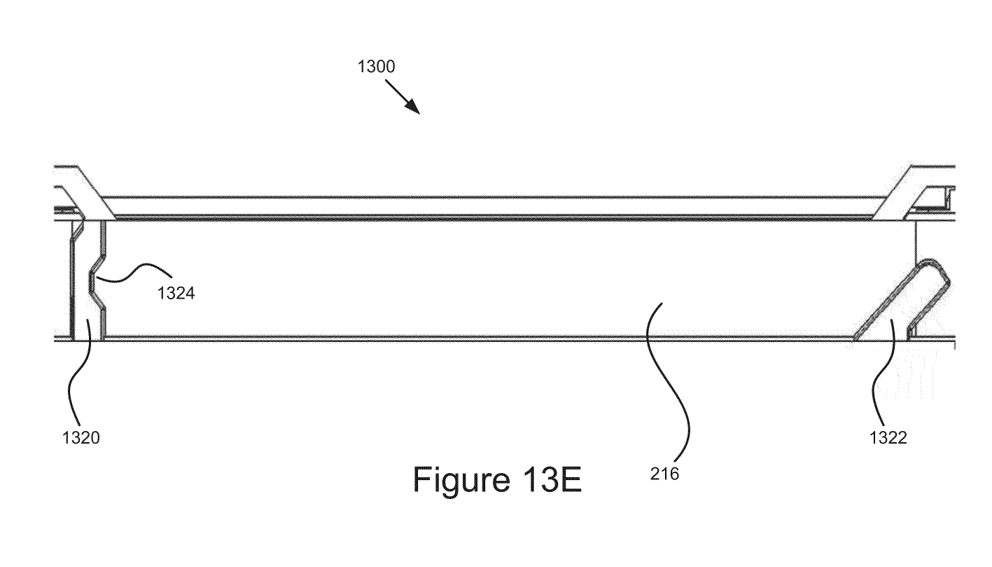

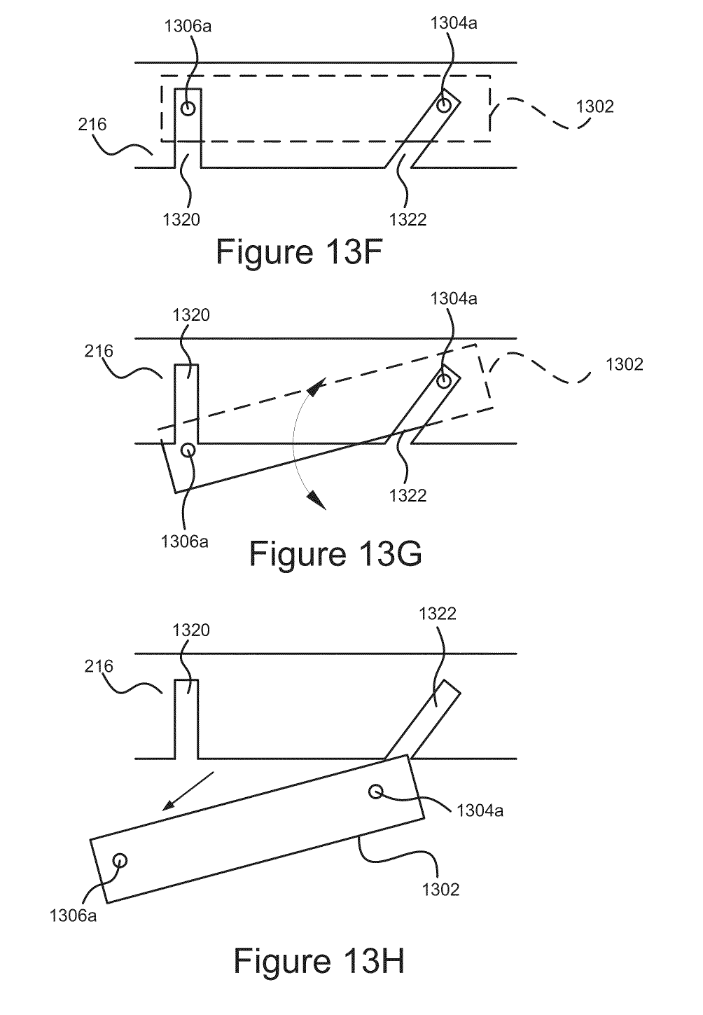

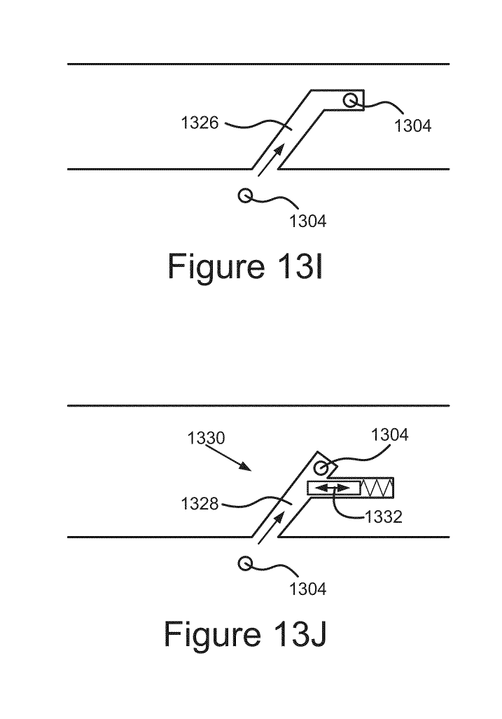

FIG. 7 is perspective view, partially in section, of a first embodiment of a connector 107a and the bottom chassis member 216 of the game controller assembly 101. The connector 107a couples the circuits 208 (not shown in FIG. 7) with the user computing device 135 when the user computing device 135 is housed within the game controller assembly 101. For example, the first embodiment of the connector 107a is a pivot connector. The connector 107a may be an eight pin Lightning connector. In the illustrated embodiment, the connector 107a is mounted or attached on the top of on a vertical slide 702 that can also pivot. The connector 107a allows a user to connect to the user computing device 135 for data transmission and/or power charging while the user computing device 135 is outside the game controller assembly 101 as well as slide inside the game controller assembly 101. In other embodiments, the connector 107 can be a dongle (“a loose cable with a connector at the end”) to couple the user computing device 135 to the game controller assembly 101. A pivoting connector 107a is particularly advantageous in conjunction with use of angled slots (See FIGS. 13A-13J below) for the clip system because if properly engineered, it will align the user computing device 135 to the correct position to mate with the connector 107a. By aligning the natural angle of the connector 107a along the same angle of the slots, the connector 107a is easily mated with the user computing device 135. The connector 107a then pivots with the user computing device 135 as it is locked in place. The simplicity of this design also leads to a more compact and robust product as a whole.

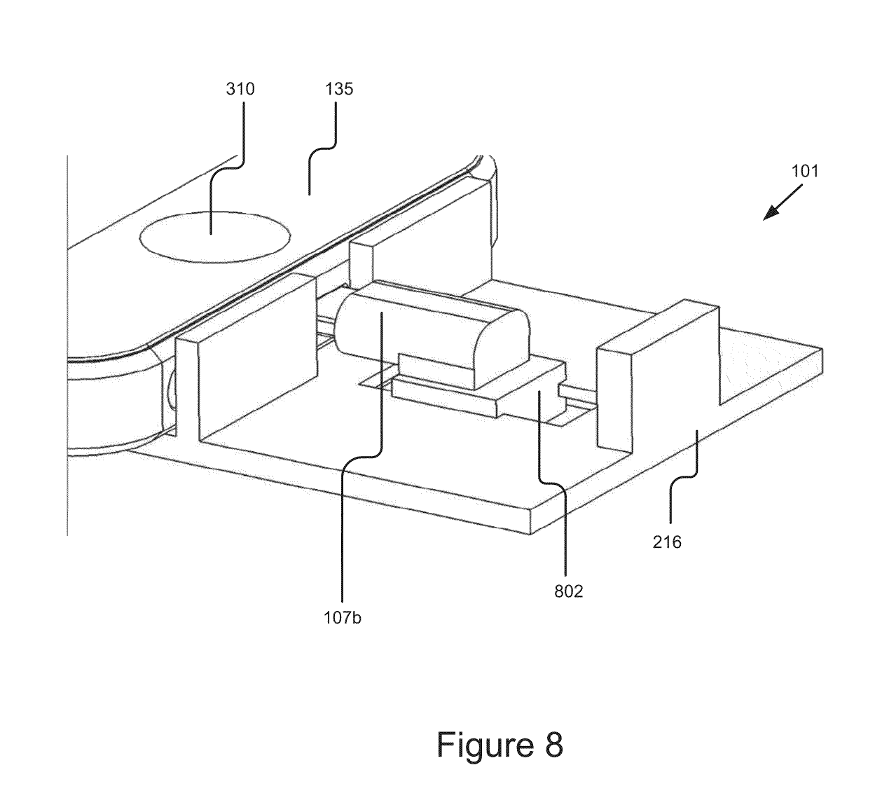

Referring now to FIG. 8, a second embodiment of a connector 107b and the bottom chassis member 216 of the game controller assembly 101 is shown. The second embodiment of the connector 107b is shown connected to the user computing device 135. For example, the connector 107b is a track slide connector. In the illustrated embodiment, the connector 107b is on a track slide 802 and connects to the user computing device 135 after the user computing device 135 is already placed inside the game controller assembly 101.

As shown in FIGS. 7 and 8, the pivot connector 702 and track slide 802 solve an important space constraint problem with the game controller assembly 101 and the user computing device 135, e.g., a smart phone. Specifically, the connectors 107a, 107b and the connection mechanism 702, 802 described above with reference to FIGS. 7 and 8 keep the controller 101 fitting tightly around the user computing device 135, e.g., a smart phone, while allowing the user to quickly and easily connect the user computing device 135, e.g., a smart phone to the controller 101.

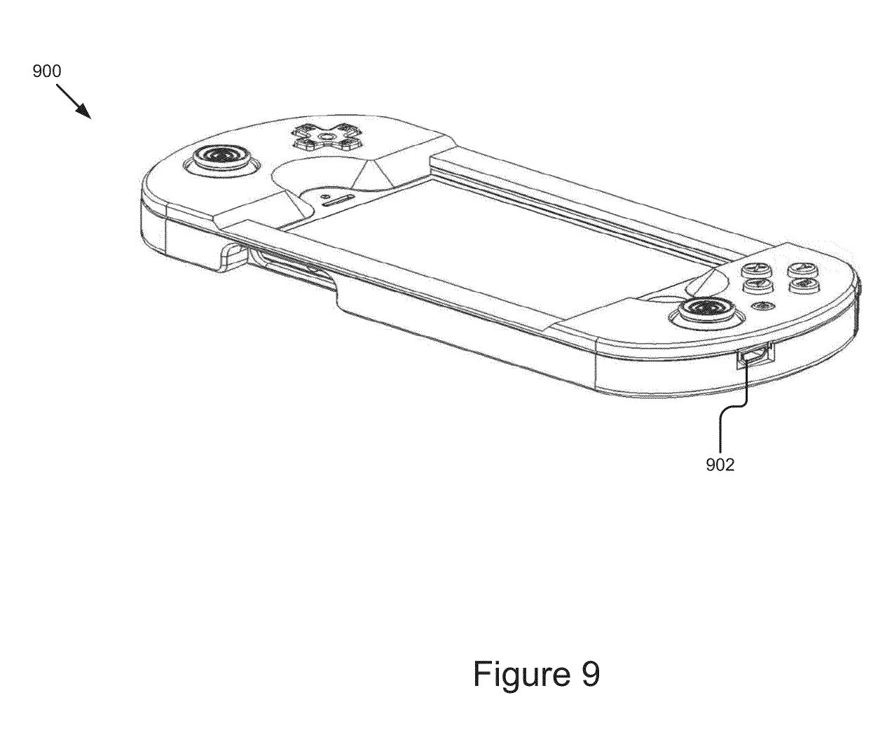

Referring now to FIG. 9, depicted is a second embodiment of game controller assembly 900 illustrating a port 902 for charging. The port 902 in the figure is an outlined location for the port 902 that would charge the game controller assembly's battery and charge the user device's battery. The port 902 is preferably a mini-USB port for charging the game controller assembly 900. The port 902 is position near the end of the game controller assembly 900. It should be understood that the port 902 could alternatively be on any side of the game controller assembly 900 in other locations.

### Methods

FIG. 10 is a flow diagram illustrating a method 1000 of power management for the game controller assembly 101 and the user computing device 135 according to one embodiment. In the illustrated embodiment, the method 1000 includes connecting 1002 the game controller assembly 101 to a user computing device 135 (e.g., a phone). The method 1000 also includes charging 1004 a Lithium Ion Battery of the game controller assembly 101. The method 1000 includes determining 1006 if the game controller assembly's battery life is less than 10%. If so, the method 1000 includes not providing 1008 charge to the user computing device 135. For example, if the game controller assembly 101 determines that its battery life is less than 10%, the game controller assembly 101 does not provide charge to the phone's battery. The method 1000 returns back to step 1004 to keep charging the controller's battery.

The method 1000 also includes requesting 1010 current battery life of the user computing device 135. For example, the game controller assembly 101 sends a request for current battery life of the user computing device 135. The method 1000 includes determining 1012 if the current battery life of the user computing device 135 is less than 15%. If so, the method 1000 begins providing 1014 charge to the user computing device 135. For example, if the game controller assembly 101 receives data from the user computing device 135 indicating the battery life of the phone is less than 15%, the game controller assembly 101 begins providing charge to the user computing device's battery. The method 1000 then sets 1016 a Boolean

CHARGING value to true.

The method 1000 also determines 1018 if the current battery life of the user computing device 135 is greater than 15% and less than 85%. If so, the method 1000 determines 1020 whether the Boolean CHARGING value is true and if the Boolean CHARGING value is true, the method 1000 provides charge to the user computing device 135; if the Boolean CHARGING value is false, the method 1000 does not provide charge to the user computing device 135.

The method 1000 also determines 1022 if the current battery life of the user computing device 135 is greater than 85%. If so, the method 1000 does not provide 1024 charge to the user computing device 135. The method 1000 also sets 1026 the Boolean CHARGING value to false.

The method 1000 is particularly advantageous because by including a Boolean loop the method 1000 of power charging and management ensures charging only occurs once the battery life of the user computing device 135 drops below 15%. Also, all skilled persons in the art will appreciate that all percentages of battery life described above are examples, and the actual percentage level may change according to each specific situation.

### Other Designs

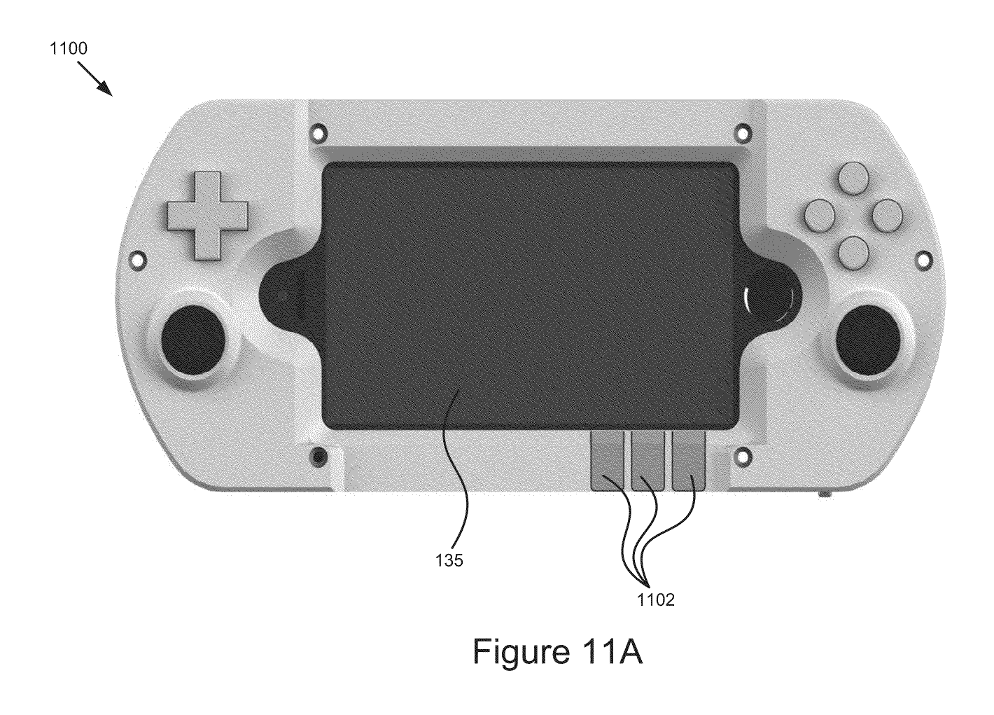

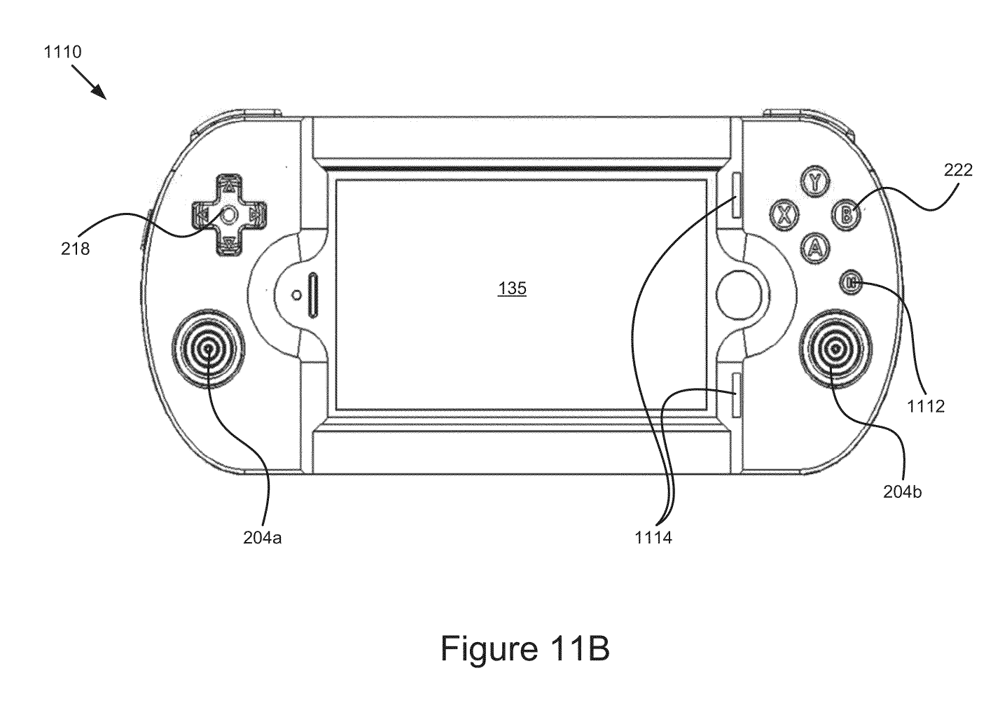

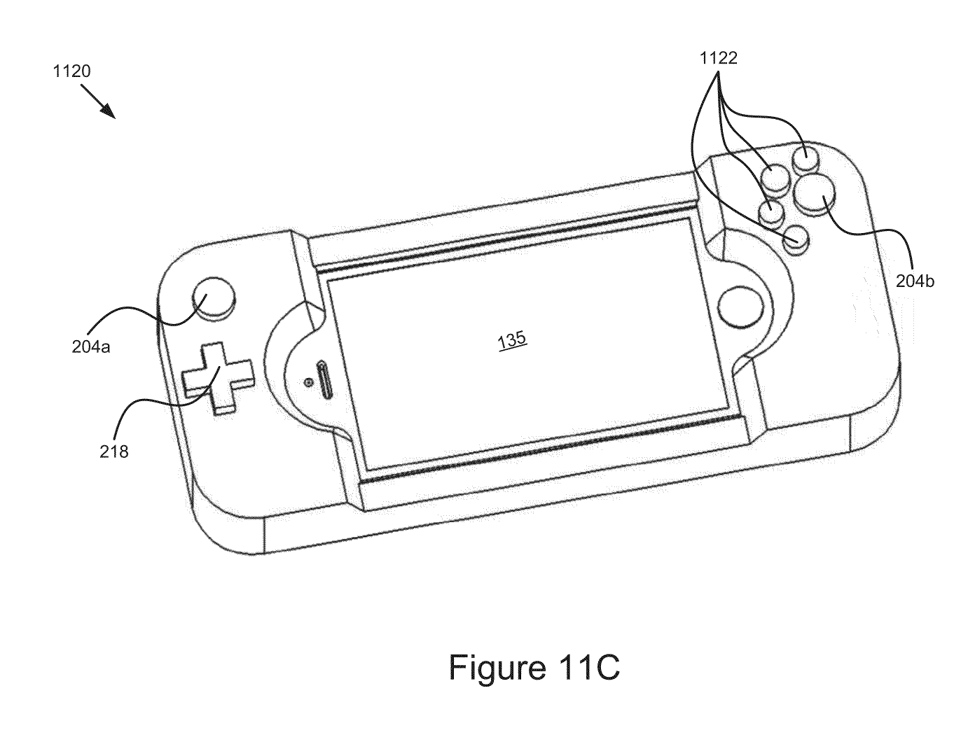

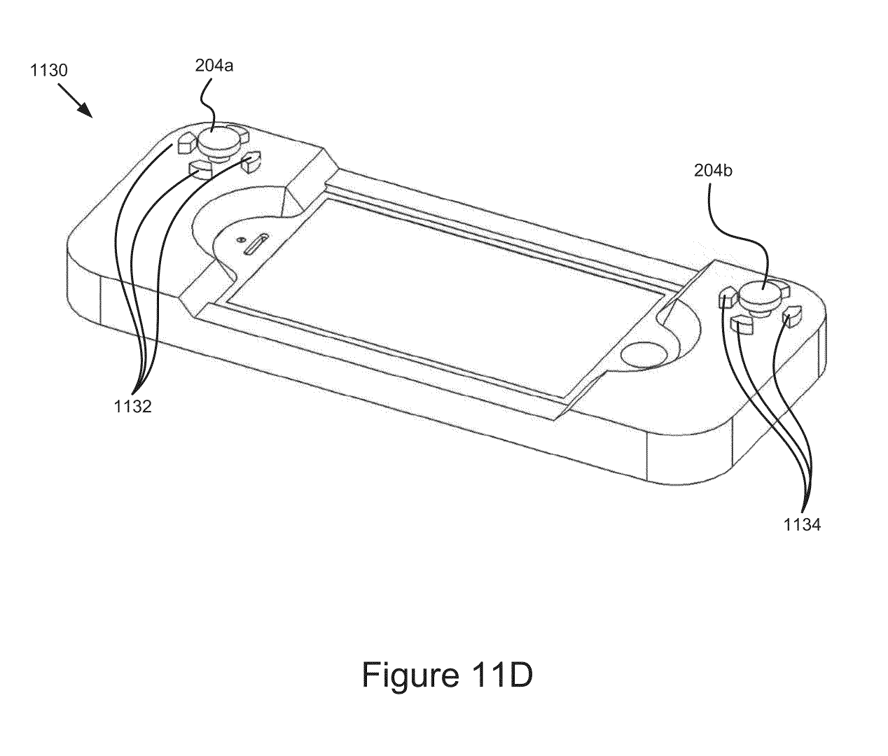

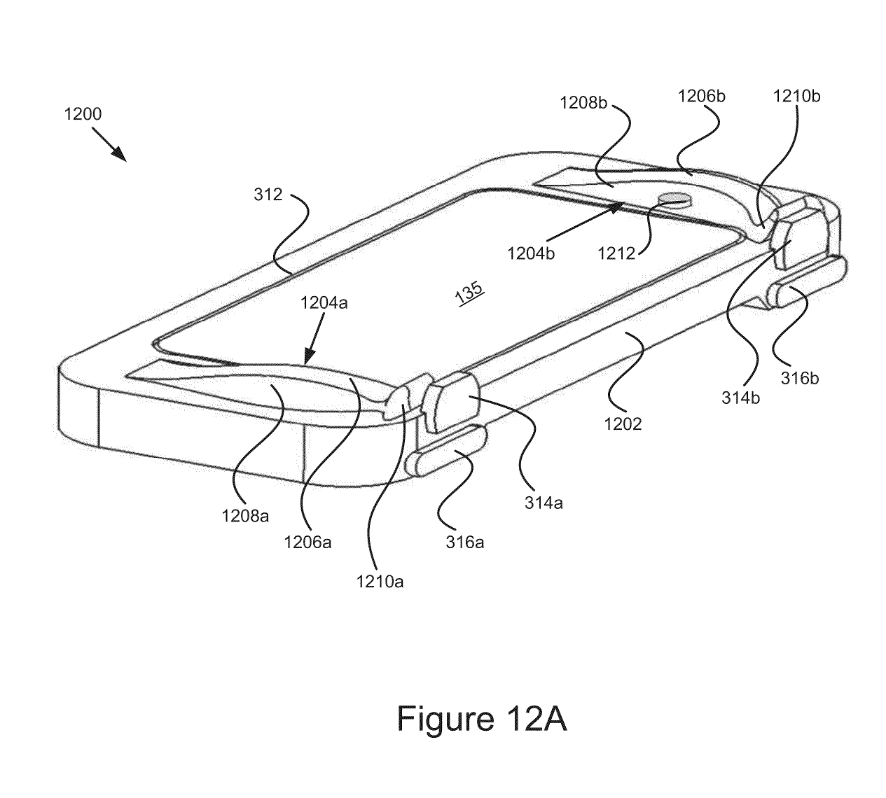

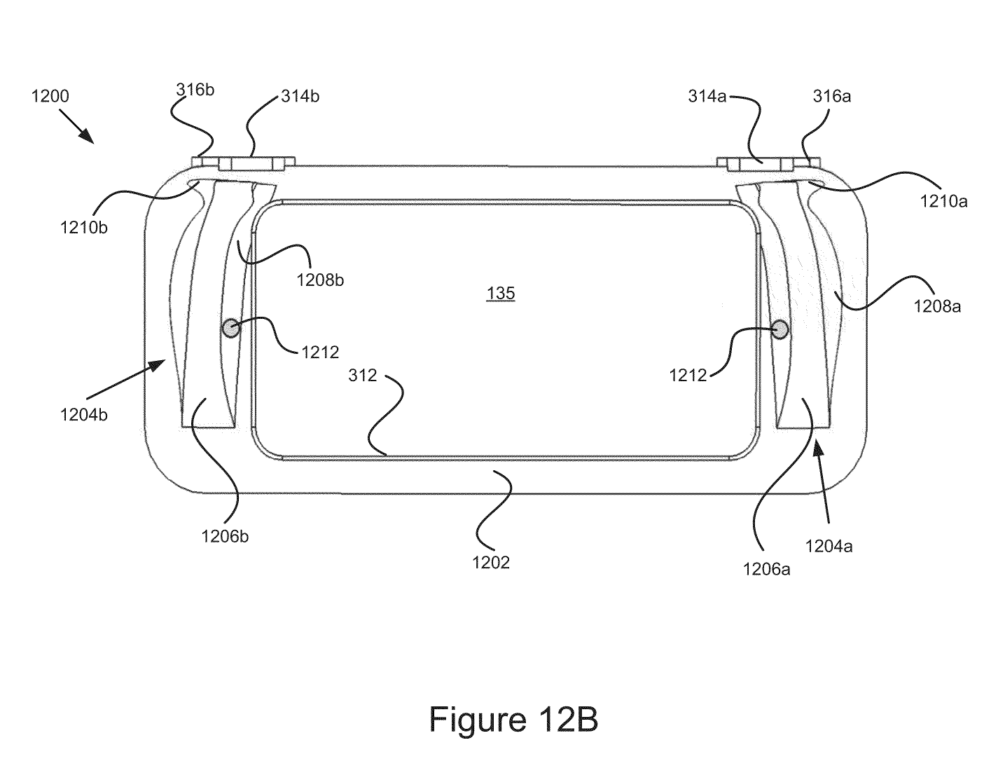

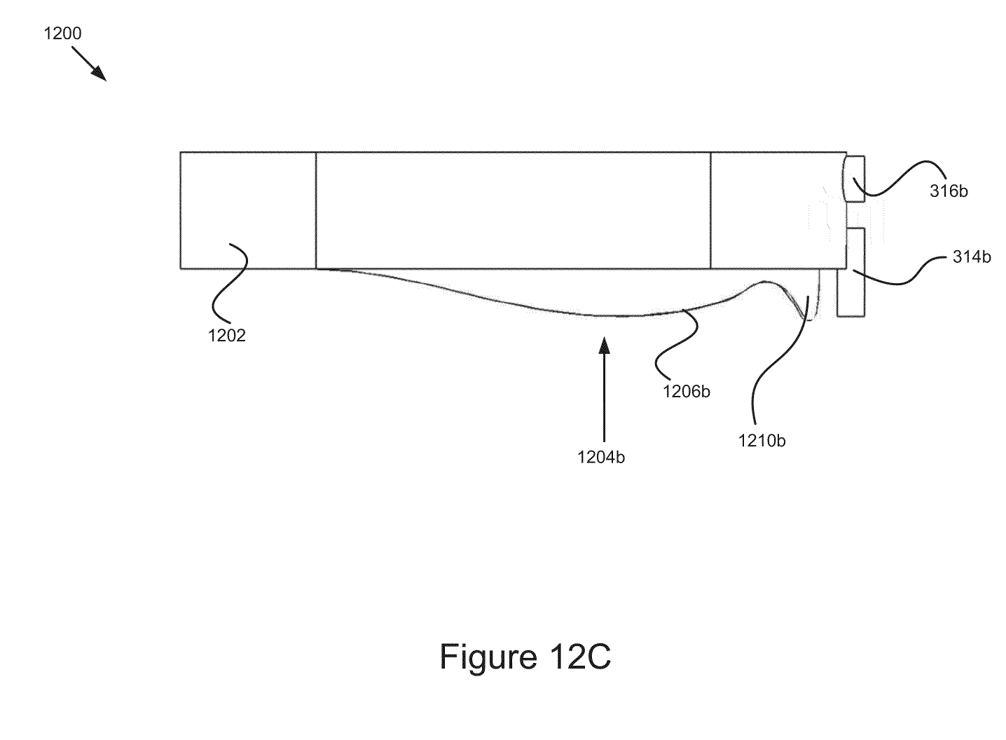

Referring now to FIGS. 11A-12C, various different other embodiments showing modifications to the basic game controller assembly 101 that was described above with reference to FIGS. 1-10 will be described.

For example, in one modified embodiment (not shown), built-in speakers can be included within the game controller's chassis such as in cavities 212a, 212b. The built-in speakers can be located on the top chassis member 202 (or faceplate) in the top right and left corners, above and away from the buttons 204, 206, 220 and 222 and directional pad 218.

FIG. 11A shows a top plan view of a third embodiment of the game controller assembly 1100. The third embodiment of the game controller assembly 1100 includes an additional set of utility buttons 1102 located on the bottom of the top chassis member 202. These utility buttons 1102 may take the form of a flat or square button, or other push button, and are located in a parallel series on the bottom edge of the game controller assembly 1100 below the user computing device 135. These buttons 1102 are particularly advantageous because their location is ideally suited for interactions with the screen of the user computing device 135. In one example, a game icon or menu option can be placed on the screen of the user computing device 135 above the corresponding utility button 1102. When the button 1102 is pressed, the game icon or menu option is activated.

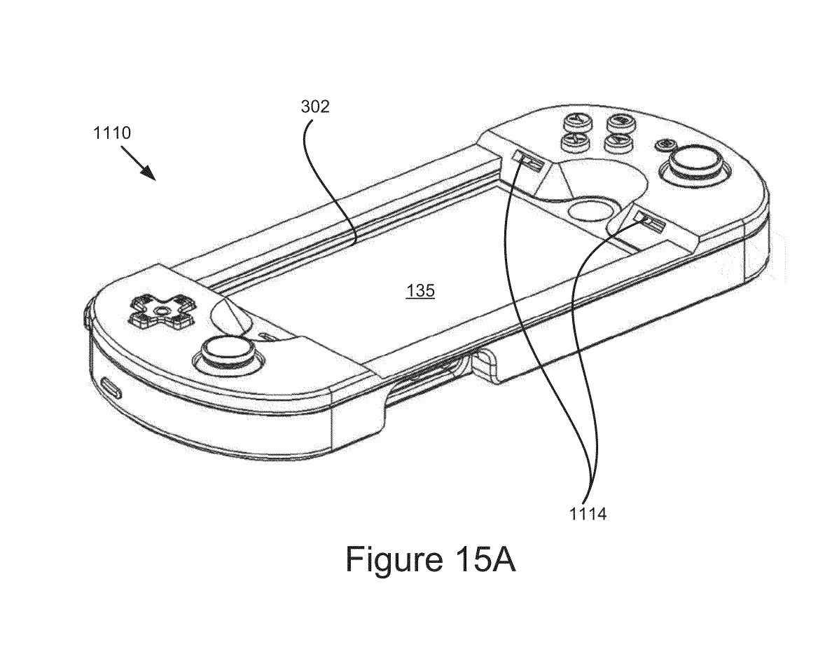

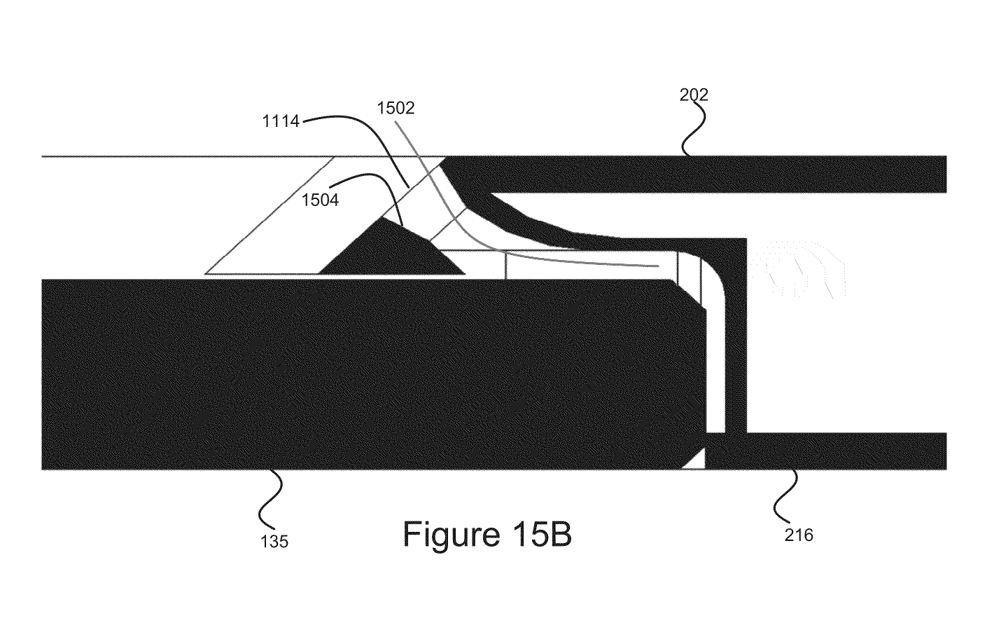

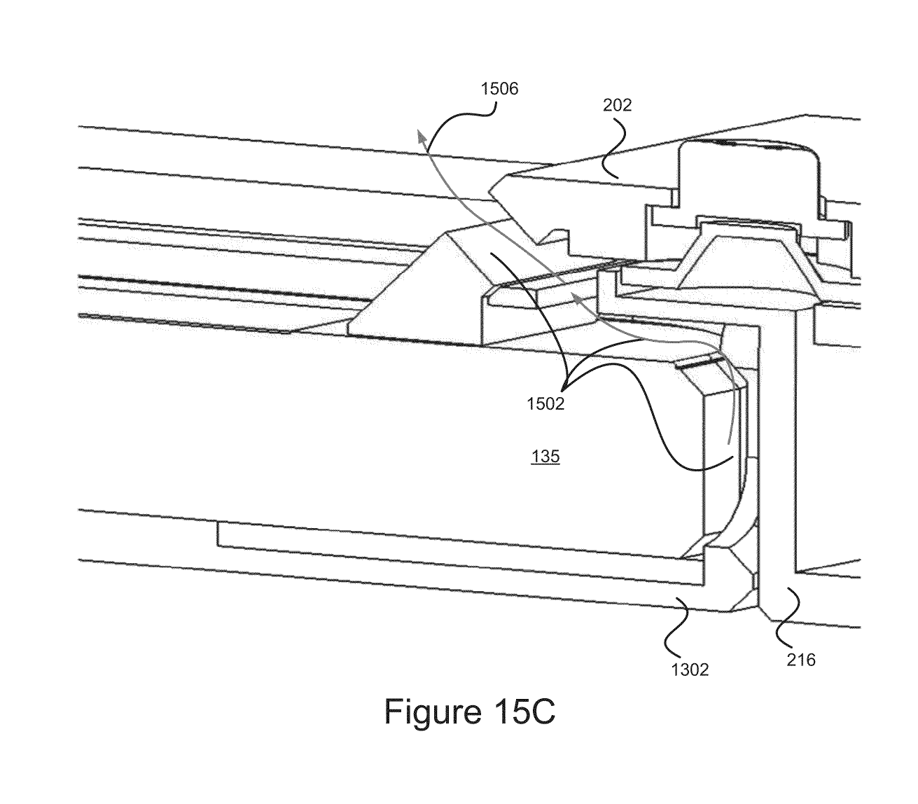

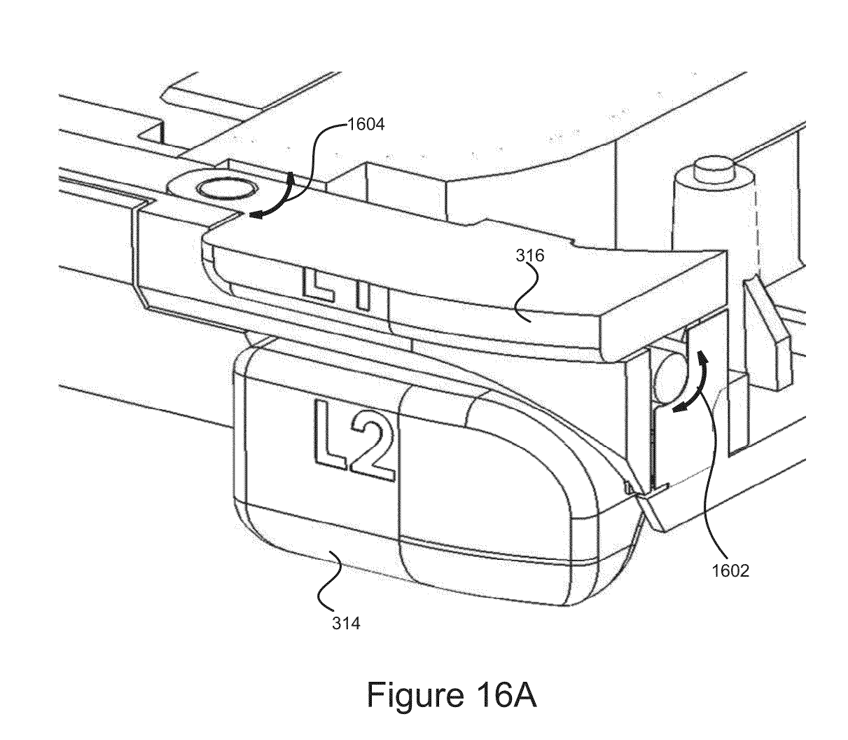

FIG. 11B shows a top view of a fourth embodiment of the game controller assembly 1110. This embodiment of the game controller 1110 is similar to prior embodiments; however, the buttons 204, 222 and directional pad 218 are modified in position, the top chassis member 202 provides additional audio ducts 1114 for audio signals and a pause button 1112 is provided. The joysticks 204 are positioned closer to the longitudinal axis of the game controller assembly 1110 along the left and right side portions. Additionally, the directional pad 218 is positioned on an opposite side of the longitudinal axis of the game controller assembly 1110 from the joystick 204a. Similarly, the third set of buttons 222 is also positioned on an opposite side of the longitudinal axis of the game controller assembly 1110 from joystick 204b. The pause button 1112 is provided positioned between the joystick 204b and the third set of buttons 222. Finally, audio ducts 1114 are provided to provide a waveguide for sounds to travel from the speakers of the user computing device 135 outward toward the front of the game controller assembly 1110 when the user computing device 135 is inserted inside of the game controller assembly 1110. The audio ducts 114 will be described in more detail below with reference to FIGS. 15A-15C.

FIG. 11C shows a perspective view of a fifth embodiment of the game controller assembly 1120. The fifth embodiment of the game controller assembly 1120 is similar to prior embodiments; however, the buttons 204 and directional pad 218 are modified in position, and a new button configuration is provided for buttons 1122. In this embodiment, the joysticks 204a, 204b are positioned near the corners of the game controller assembly 1120. The directional pad 218 is positioned on the longitudinal axis of the game controller assembly 1120 proximate the left end. The buttons 1122 have a crescent shaped array positioning near and interior side of the right joystick 204b. Additionally there are four buttons 1122 in the crescent configuration. These four buttons 1122 make up the action button group but by placing them all on one side and equidistant from the joystick 204b center, all buttons 1122 in the action button group are equally accessible to the right thumb. This makes for easier utilization of the full action button 1122 group even while the right joystick 204b is also in use. In other words, the buttons 1122 are positioned on a curve approximately the same distance from the center of the joystick 204b. FIG. 11C show only one positioning for the crescent configuration of the buttons 1122, but it should be understood that there may be others. This configuration of the buttons 1122 is particularly advantageous because it makes the buttons 1122 easy to access by a user whose thumb is on the joystick 204b thereby providing better ergonomics for the user for extended play. The crescent configuration is also advantageous because it reduces the amount of surface area necessary to provide four buttons 1122, and thus allows for overall saving in surface area and a more compact design.

FIG. 11D shows a perspective view of a sixth embodiment of the game controller assembly 1130. The sixth embodiment of the game controller assembly 1130 is similar to prior embodiments; however, the joysticks 204 are raised in profile and the buttons 1132, 1134 have different configurations. In this embodiment, the joysticks 204a, 204b are positioned near the corners of the game controller assembly 1130. The joysticks 204a, 204b are ensconced by the various other face buttons 1132, 1134 including the four action buttons 1134 surrounding the right joystick 204b and the four buttons 1132 that make up a directional pad which surround the left joystick 204a. The joysticks 204a, 204b have an increased profile and extend farther above the top surface of the game controller assembly 1130. This is advantageous because it allows the buttons 1132, 1134 to be positioned closer to the joysticks 204a, 204b thereby saving precious surface area. The buttons 1132, 1134 are arranged in a radial array about the periphery of the joysticks 204a, 204b, respectively. While each radial array is shown as having four buttons 1132, 1134, there may be fewer or greater numbers of buttons in each array. Another advantage of this embodiment is that it minimizes the distance that the user's thumb must move in order to reach each button 1132, 1134. This allows users with smaller hands to more comfortably handle game controller assembly 1130 and yet it does not impede on handling by users with larger hands. Again, placement of the four buttons 1132, 1134 in a radial array about each joystick 204a, 204b provide excellent ergonomics for the user, and the differing heights between the buttons 1132, 1134 and the joysticks 204a, 204b provides good differentiation so that buttons 1132, 1134 are not accidentally. There are many possible arrangements for the buttons and joysticks that the game controller assembly 1100, 1110, 1120 and 1130 are merely a few examples.

Ergonomics are of particular concern when considering the strain of prolonged use of any game controller device. To help with this issue, a seventh embodiment of the game controller assembly 1200 is provided. The seventh embodiment of the game controller assembly 1200 has a chassis with improved ergonomic design.

FIG. 12A shows a bottom perspective view of the seventh embodiment of the game controller assembly 1200. In this embodiment, the back of the game controller assembly 1200 is designed with a pair of raised contoured protrusions 1204a, 1204b that conform more closely to the shape of the human hand. Each of the contoured protrusions 1204a, 1204b has a longitudinal axis parallel to the shorter sides of the game controller assembly 1200. The contoured protrusions 1204a, 1204b are positioned on the bottom of game controller assembly 1200 on opposite sides of the opening 312 near the shorter sides of the game controller assembly 1200. The contoured protrusions 1204a, 1204b extend laterally from near the button 314 toward the opposite longer side of the game controller assembly 1200. The contoured protrusions 1204a, 1204b are higher near the middle and are tapered to be narrower toward the end so that they have an outer side 1208a, and an inner side 1208b with a leaf-like elliptical shape. The top 1206a, 1206b has a relatively flat curved band-like shape. The ends 1210a, 1210b of the contoured protrusions 1204a, 1204b proximate the button 314 are increased in height from the surface of the bottom side. The ends 1210a, 1210b of the contoured protrusions 1204a, 1204b extend just beyond the length of the trigger buttons 314a, 314b, respectively, and in so doing, provides an additional function of protection the trigger button 314a, 314b from some potential damage. This quality makes this or similar embodiments particularly advantageous by not only increasing user comfort but also increasing the durability of the game controller assembly 1200 while still maintaining a compact envelope. Additionally, by curving the inside edge of contoured protrusions 1204a, 1204b this embodiment allows for improved grip on the game controller assembly 1200. Additional, the inner side 1208b defines an area that can be used to put additional buttons 1212 for example for a push to talk or other functionality. FIG. 12B shows a bottom plan view of the seventh embodiment of the game controller assembly 1200. FIG. 12C shows a side view of the seventh embodiment of the game controller assembly 1200.

FIG. 13A shows an exploded perspective view of an eighth embodiment of the game controller assembly 1300, the user computing device 135 and a case 1302. In this eighth embodiment of the game controller assembly 1300 cooperates with a case 1302 that in turn holds the user computing device 135. The eighth embodiment of the game controller assembly 1300 is similar to other embodiments described above and has a plurality of buttons on its top and around his periphery and defines an opening 302, 312 for receiving and holding both the case 1302 and the user computing device 135. The dashed lines in FIG. 13A illustrates the alignment between the openings 302, 312 of the game controller assembly 1300, the user computing device 135 and the case 1302. Additionally, dashed line 1308 shows a first step of inserting the user computing device 135 into the case 1302. Once the user computing device 135 has been inserted into the case 1302, the sides, top edge and bottom edge of the corresponding top and bottom surfaces are encompassed by the case 1302 other than the cutouts provided to access the connectors and buttons of the user computing device 135. A second dashed line 1310 illustrates the insertion of the case 1302 holding the user computing device 135 into the game controller assembly 1300. It should be noted that the opening 312, 302 defined by the game controller assembly 1300 are sized to accommodate the case 1302 including the user computing device 135. FIG. 13A shows mating pins 1304a and 1306a that mate with slots 1320, 1322 in the opening 312 on the game controller assembly 1300 as will be described in more detail below. This embodiment is particularly advantageous because the user computing device 135 is protected at all times by the case 1302. If used the game controller assembly 1300, the user computing device 135 is protected, but fully accessible by both the game controller assembly 1300 and the case 1302. However, when not in use with the game controller assembly 1300, the user computing device remains protected, but fully accessible by the case 1302.

FIG. 13B shows a top plan view of the case 1302, holding the user computing device 135 for use with the eighth embodiment of the game controller assembly 1300. FIG. 13B shows an example location, position and configuration for pins 1304a, 1304b, 1306a, 1306b along the longitudinal sides of the case 1302. It should be understood that additional pins could be use, in other position and size configurations.

FIG. 13C shows a cross-section view of the case 1302 taken along line 3C-3C of FIG. 3A. This shows an example embodiment of the size and shape of pins 1306a, 1306b.

FIG. 13D shows a bottom perspective view of the eighth embodiment of the game controller assembly 1300. FIG. 13E shows a sectional view a portion of the chassis 216 of the eighth embodiment of the game controller assembly 1300. These figures show the position and orientation of slots 1320, 1322 defined by the bottom chassis member 216 of the game controller assembly 1300. These slots 1320, 1322 receive pins 1304a, 1304b, 1306a, 1306b of the case 1302 to secure the case 1302 in a locked position inside of the game controller assembly 1300. This embodiment advantageously uses a combination of vertical slots 1320 and the angled slots 1322 as a mounting mechanism for easy, but secure insertion of the case 1302 into the one the game controller assembly 1300. It should also be noted that the angled slot 1322 helps hold the pin 1304a from falling out of the slot 1322. The vertical slot 1320 also includes a passive locking mechanism. More particularly, the bump or protrusion 1324 in the slot 1320 hold the pin 1306 in the upper part of the slot 1320. The lock is passive, locking by physical structure and insertion and removal would be by force. Pushing the pin 1306 past the bump or protrusion 1324 keeps and holds the pin 1306 captive so that the case is not unintentionally removed.

FIGS. 13F-H show a side view of different stages of the action required to remove or insert the case 1302 into the mounting portion (the slots 1320, 1322) of the game controller assembly 1300. For example, if the user is trying to remove the user computing device 135 in the case 1302 from the mounting portion (the slots 1320, 1322) then the user performs the action shown in FIGS. 13F, 13G and 13H to remove the case 1302 from the game controller assembly 1300. In contrast, if the user is trying to connect the case 1302 holding the user computing device 135, the user performs the action shown in FIGS. 13H, 13G and then 13F. FIG. 13F illustrates the case 1302 fully positioned and attached to the game controller assembly 1300. FIG. 13G illustrates the case 1302 partially removed or inserted from the game controller assembly 1300. For example, a portion of the case 1302 may be lifted so that the pins 1306a, 1306b are outside the vertical slot 1320 while another set of pins 1304a, 1304b in the angled slot 1322 remain coupled to the game controller assembly 1300. FIG. 13H illustrates a step after or before that of FIG. 13G in which neither set of pins 1306a, 1306b, 1304a, 1304b has yet engaged with the vertical slot 1320 or the angled slot 1322.

FIGS. 13I and 13J show various embodiments for slots 1326, 1328 and their interaction with a pin 1304 of the case 1302. For example, FIG. 13I shows a compound or L-shaped slot 1326 that provides additional support to hold the pin 1304 in the locked position. FIG. 13J shows an example of an angled slot 328 including an active locking mechanism 1330. The active locking mechanism 1330 includes a spring and an arm 1332. The spring pushes the arm 1332 to block the slot 1328 and prevent passage of pin 1304. This holds the pin 1304 in place. The spring loaded arm 1332 can be moved laterally to allow the pin 1304 to pass out of the slot 1328. Alternatively, the locking mechanism could be active using springs, levers, or other means to lock the pin into place. The active lock would be released by a user action to remove the barrier. It should be recognized that other configurations and combinations of slots and locking mechanisms may be used other that described above with reference to FIG. 13D and 13E. For example, an active locking mechanism may be used on the vertical slot 1320 instead of a passive locking mechanism. Likewise the passive locking mechanism may be used on the angled slot 1322 even though not shown in the Figures.

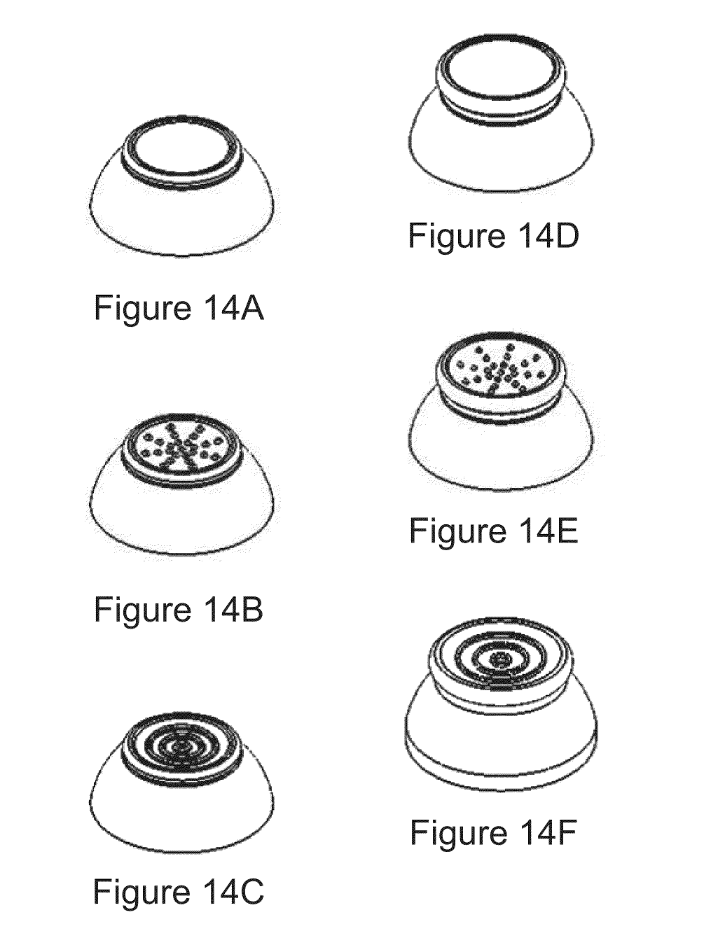

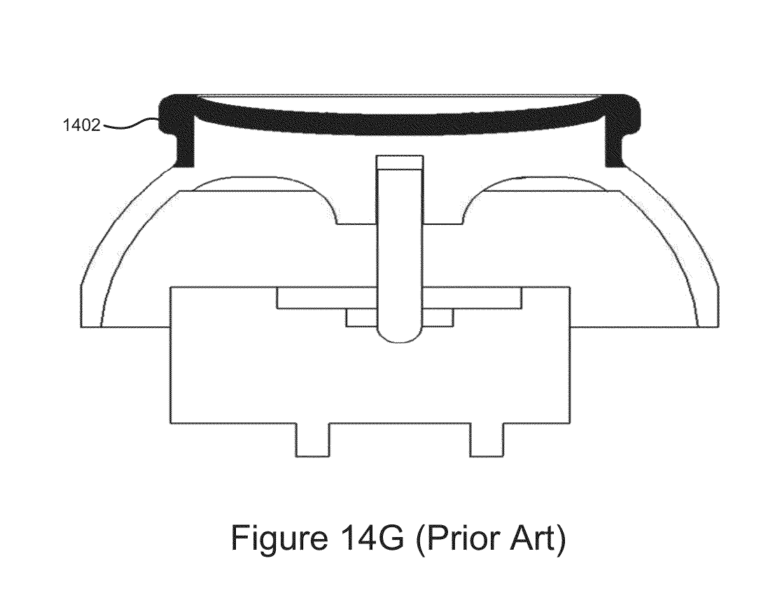

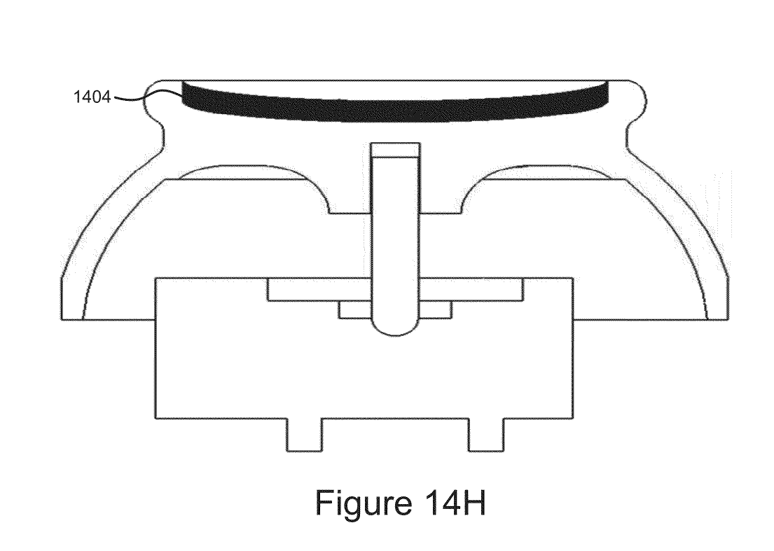

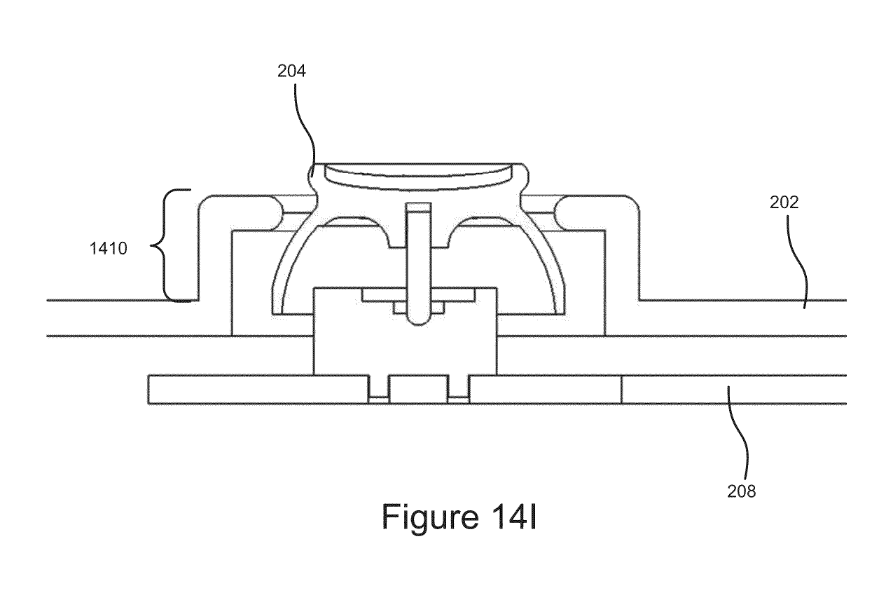

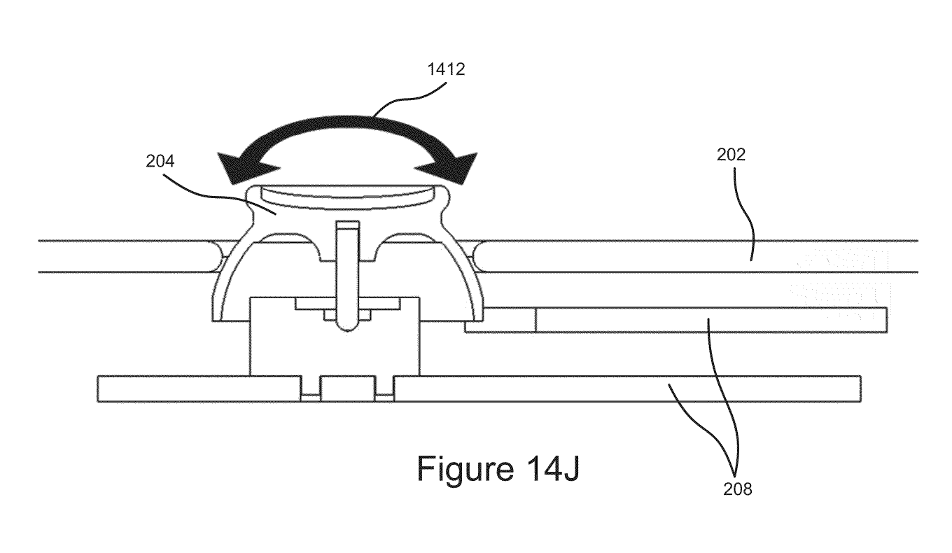

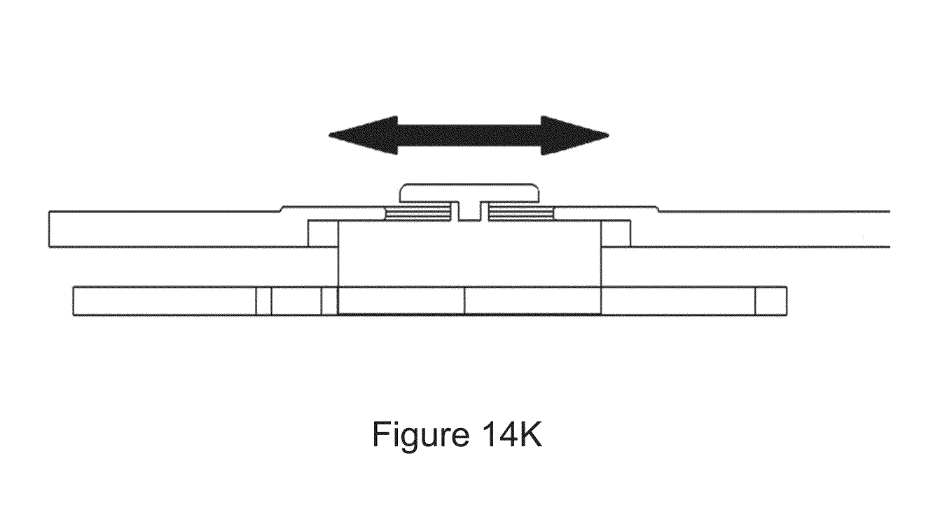

FIGS. 14A-14K show various embodiments for joysticks and joystick configurations. FIGS. 14A-14F show different configurations for the surface of the joysticks to provide different or better tactile feel. Any of the example joystick embodiment in FIGS. 14A-14F can be used in place of joysticks 204a, 204b. Joysticks require a cap that fits over the electronic component. The joystick caps of the present invention have been designed to balance a low profile with providing the best tactile feedback and comfort for the user. The height, shape and texture of the cap can be designed in many ways. FIGS. 14A-14F show different embodiments of Joystick caps. The caps themselves can be made of a wide variety of materials or combinations of materials. In most instances there is a hard plastic core, which is coated in softer rubber 1402, as shown in FIG. 14G. In a preferred embodiment, the present invention uses a smaller amount of rubber 1404 restricted to a pocket in the top of the cap as shown in FIG. 14H. Rubber has a tendency to catch or stick to cloth, skin and other surfaces. The cap shown in is FIG. 14G advantageous while the joysticks are in use; however, rubber is cumbersome while inserting and removing the game controller assembly 101 from pockets, bags or other similar instances. By raising the hard plastic lip above the height of the rubber 1404, contact between the rubber and other surfaces will be minimized, but will not negatively impact the gameplay experience.

FIGS. 14I and 14J show a comparison of joystick 204 height above the top chassis member 202 (faceplate surface) using a single PCB or multiple PCBs. FIGS. 14I shows a conventional joystick and the needed height 1410 above the top chassis member 202 (faceplate surface) to accommodate the vertical height of the joystick 204. In other words, the top chassis member 202 must be extended outward increasing the vertical height of the game controller assembly 101. In this example, there is only a single PCB and this requires the switch associate with the joystick 204 be mounted on the PCB 208, thus the joystick cannot be recessed. In contrast, FIG. 14J shows an embodiment where the PCB is divided into multiple pieces. This allows the joystick 204 to be recessed. Breaking the PCB into parts and dropping part of it down as low as possible in the top chassis member 202 allows use of taller joystick electronics without significantly increasing the overall height of the game controller assembly 101. For example, as shown in FIG. 14J, the top chassis member 102 is planar with no extended support for the joystick 204. The height savings allowed by this multi PCB system are significant enough to allow for use of different technology in the form of true articulated joysticks. Articulation in joysticks is very important for providing the correct tactile feel during gameplay. The motion as reflected by arrow 1412 is in three dimensions and arcs around a sphere. This provides more natural, intuitive feedback to the user as compared with use of planar joysticks as can be seen in FIG. 14K.

Another method for reducing the envelope of the game controller assembly 101 is to use a mechanism (not shown) that would allow the joysticks to move lower into the controller when not in use. This could be accomplished by using a linear actuator, a slide, a lever, a spring and latch, or any other such mechanism that might allow the joystick component to raise and lower as needed. The simplest system electrically would utilize the multi PCB system and allow the PCBs with attached joysticks to move up and down in chassis as a single unit. It should be noted that this does not reduce the overall device envelope when in use, but rather reduce the practical envelope of the device as it pertains to mobility. When the joysticks are lowered it would be notably easier to insert the controller into pockets, purses, bags, etc. . . .

FIGS. 15A-15C show various views of an embodiment for audio ducts 1114 created in the fourth embodiment of the game controller assembly 1110. The fourth embodiment of the game controller assembly 1110 is similar to other embodiments described above and has a plurality of buttons on its top and around his periphery, cutouts for accessing the user computing device 135 and defining an opening 302 for the screen of the user computing device 135. FIG. 15A shows a perspective view of the fourth embodiment of the game controller assembly 1110 with audio ducts 1114 exiting from the top chassis 202 of the game controller assembly 1110. The audio ducts 1114 port the audio from the speaker (not shown) of the user computing device 135 through the chassis 202, 216. For example, the audio ducts 1114 provide an audio refraction channel from the speaker to the surface of the game controller assembly 1110. This works by using the principles of sound wave reflection and refraction to direct the sound through a dedicated and designed channels 1502 that lead into and out of the device chassis 202, 216. An example embodiment of one such channel 1502 is shown in FIG. 15B and 15C. In the game controller assembly 1110, multiple parts of the chassis 202, 216 have been engineered to fit together forming the channel 152 and exiting at the audio duct 1114. In the process, the opening 1504 of the channel 1502 was designed to not only direct the sound, but amplify it as well providing the user with better control over audio and enhancing the game play experience. Building this amplification 1504 into the chassis through an engineered channel means that amplification can occur with no increased load on the device's battery 103. FIG. 15C shows the interlocking chassis 202, 216 and a path 1506 that sound travels through the channel 1502

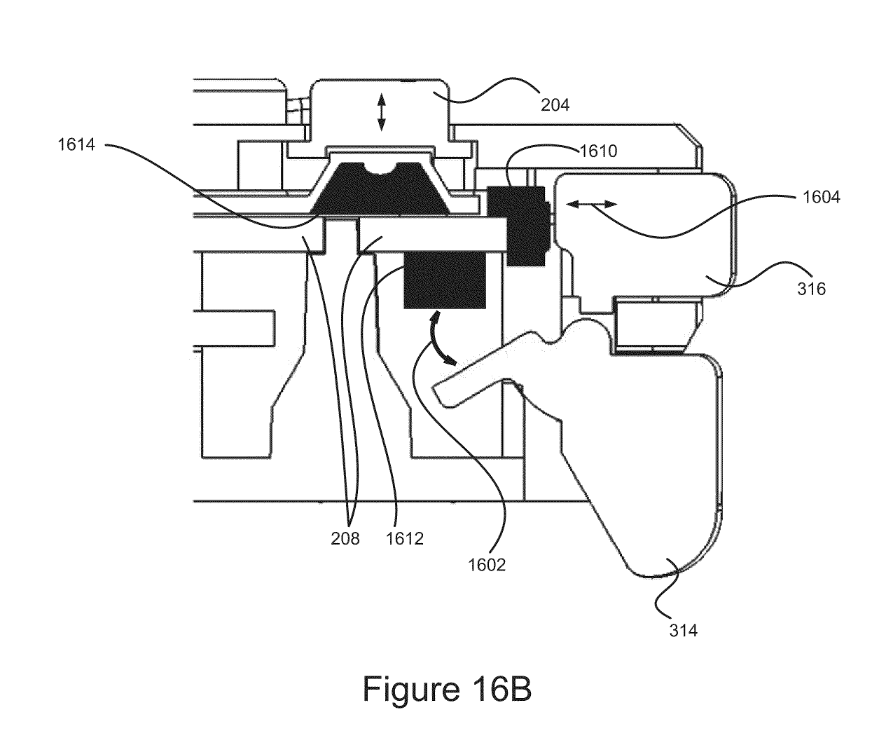

FIGS. 16A and 16B show embodiments for the buttons 314, 316 and their interface with corresponding switches. FIG. 16A is a perspective view partially in section of the shoulder buttons 314, 316. The game controller assembly 101 has two sets of shoulder buttons 314, 316. One set of buttons 316 depresses linearly as depicted by line 1604 while the other set of buttons 314 swings about a fixed axis depicted by line 1602 much like “trigger” buttons on modern console controllers. In order to accomplish this swinging motion without increasing the maximum envelope of the game controller assembly 101, separate sets of buttons 314, 316 swing about axes that are orthogonal to each other for increased switch density. The top face of the game controller assembly 101 may also have a beveled edge. This enables the duplication of the functionality of modern trigger buttons without increasing the overall envelope of the controller, which is critical in the mobile console market.

Referring now also to FIG. 16B, the present invention also allows for more efficient use of the space on the PCB 208. The linearly depressed shoulder buttons 316 are placed such that they trigger micro switches 1610 on the front of the PCB 208 while the trigger buttons 314 are placed such that they trigger micro switches 1612 mounted on the underside of the PCB 208. This conserves space on the upper surface of the PCB 208 and allows for placement of the face button switches 1614 in close proximity to the upper edge of the controller as shown in FIG. 16B. The switch density achieved herein is part of what allows our particular the game controller assembly 101 embodiment to maintain such a small envelope.

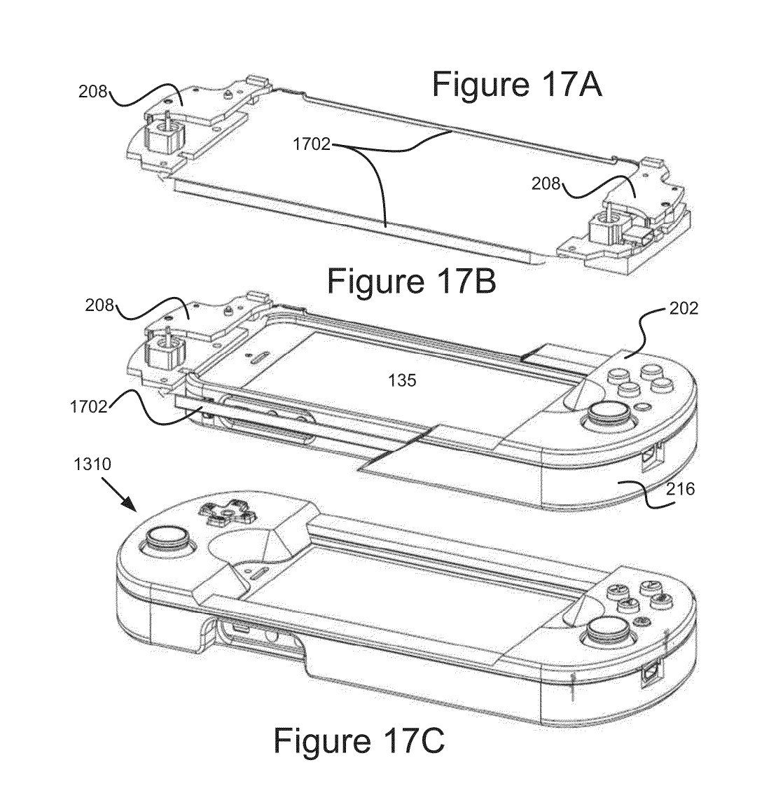

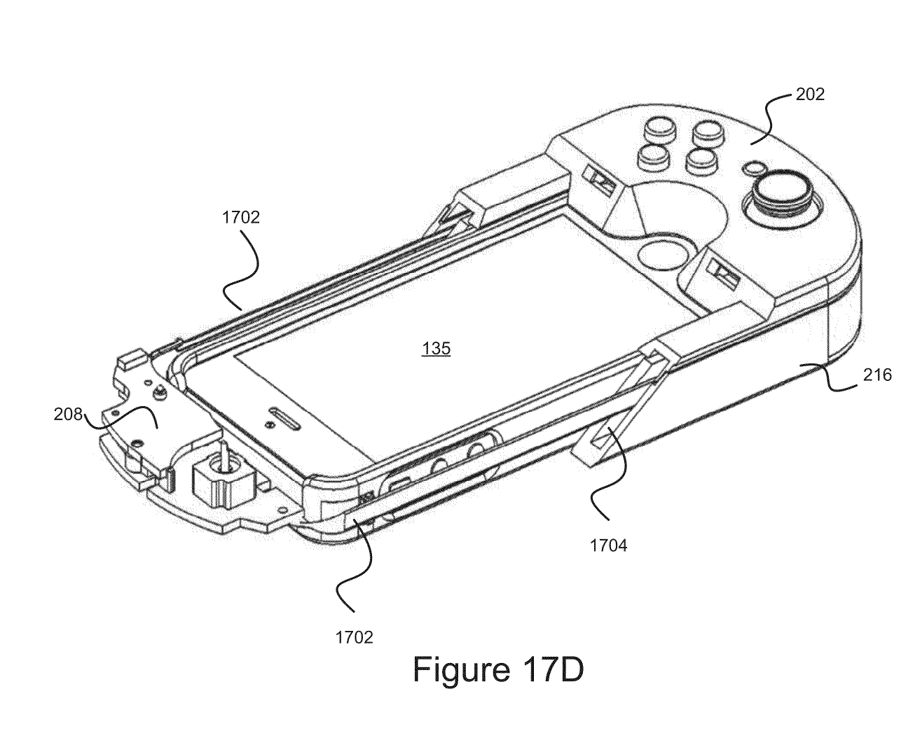

FIGS. 17A-17D shows perspective views of the eighth embodiment of the game controller assembly, partially in cross section to reveal the wring channel formed by the frame of the game controller assembly 1300. FIG. 17A shows the connector 1702 used to connect the PCBs on opposite ends of the game controller assembly 1300. FIG. 17B shows the top chassis member 202 and the bottom chassis member 216 partially in cross-section with the game controller assembly 1300 holding the user computing device 135. This figure illustrates how the top chassis member 202 and the bottom chassis member 216 form a channel for the connector 1702 on both sides of the game controller assembly 1300. FIG. 17C shows the game controller assembly exterior and holding the user computing device 135. The game controller assembly 1300 is designed to have the user computing device 135 inserted through an opening in the backside of the game controller assembly 1300. By using this insertion method the user computing device 135 can be easily inserted by pressing on the back of the user computing device 135 towards the bottom of the game controller assembly 1300 and easily removed by pressing down on the front face of the user computing device 135. Inserting the user computing device 135 through the back of the game controller assembly 1300 also allows the game controller assembly 1300 to make use of the surface area above the front side of an enmeshed user computing device 135 as referred to in the overlap section above. This allows a decrease in the maximum envelope of the game controller assembly 1300 without sacrificing functionality or ease of insertion/removal of the user computing device 135. The back-insertion strategy is enhanced by utilization of the wrap-around body of the game controller assembly 1300 as a conduit for electronic signals. The game controller assembly 1300 routes a signal bus 1702 in the form of a flexible PCB, ribbon cables, individual wires, or wire harnesses through the game controller assembly 1300 edge in an orientation perpendicular to the other circuit boards 208, taking advantage of the bending possible in the thin flex material. Flexible PCBs are particularly advantageous because their reduced thickness allows a very small space to have a high conductor density, permitting all relevant signals to be routed without need for heavy-duty busses. FIG. 17D shows the channel 1704 formed by the top chassis member 202 and the bottom chassis member 216 with the connector 1702 passing through it.

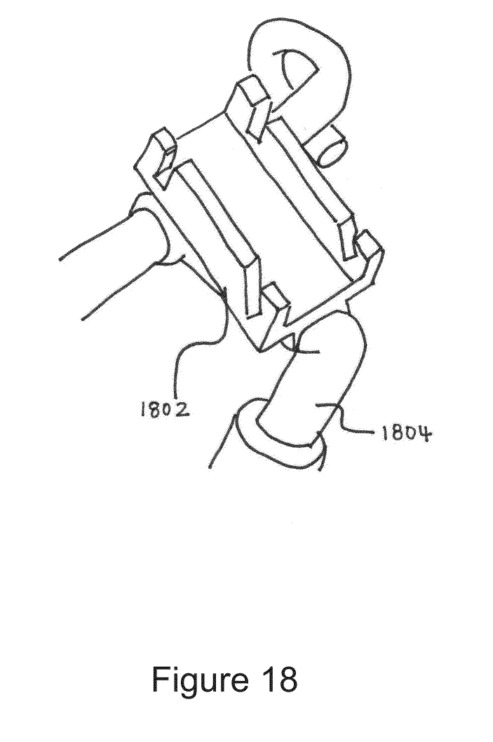

FIG. 18 is a perspective view of another embodiment of the mounting portion 1802 for cooperation with the case 1302. In this example, the mounting portion 1802 is attached to a bicycle frame. FIG. 18 is a perspective view of a mounting portion 1802, in this example mounted on a bicycle frame 1804. The mounting portion 1802 has a mounting bracket on its bottom that couples it to the bike frame 1804. The mounting portion 1802 defines a U-shaped enclosure to receive the user computing device (not shown) or the case 1302 holding the user computing device 135. The walls of the mounting portion 1802 defined slots for receiving connectors on the user computing device 135 or its case 1302. The slots may be of different sizes, shapes and orientations as shown. In this example, a pair of slots run vertically and extend along the wall of the U-shaped enclosure. Another set of slots have a similar orientation size and shape but are angled away from the lateral edge of the U-shaped enclosure.

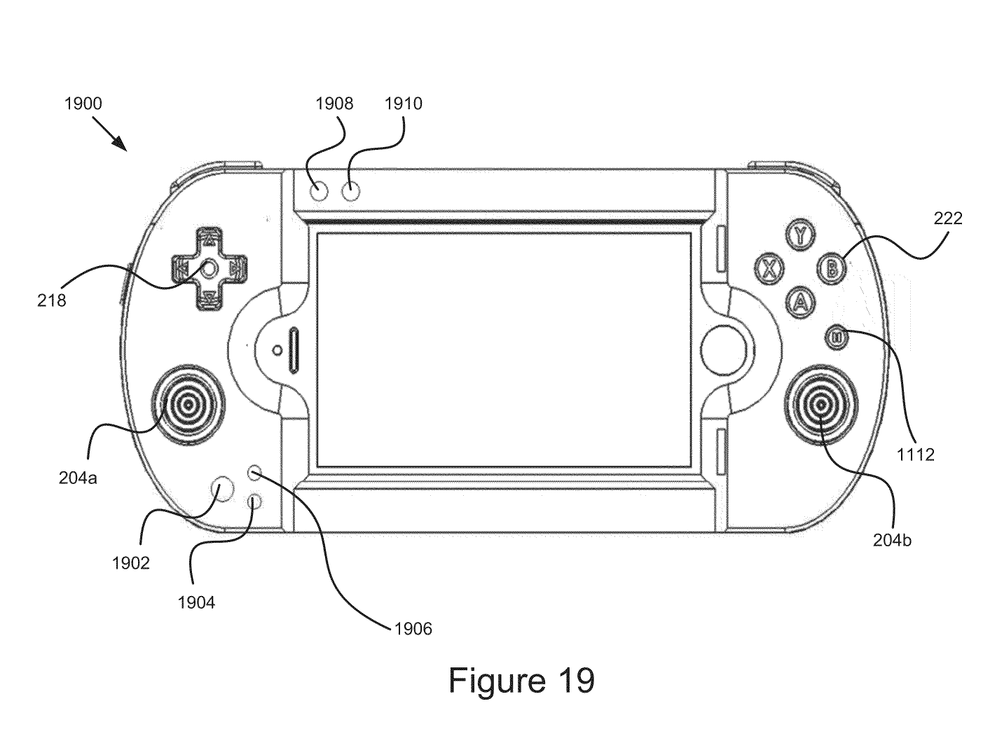

FIG. 19 is a perspective view of a ninth embodiment of the game controller assembly 1900 adapted for social interactions. The ninth embodiment of the game controller assembly 1900 is similar to other embodiments described above but also includes a share button 1902, a light 1904, a microphone 1906 and additional buttons 1908 and 1910. As shown in FIG. 19, an integrated microphone system can be added to the game controller assembly 1900.

The microphone 1906 is located on the front side of the game controller assembly 1900 as shown in FIG. 19. In FIG. 12A & 12B, addition components of the integrated microphone system are shown. In particular, the button switch 1212 is used to activate the microphone 1906. The button 1212, which can take the following forms (switch, push button, others), is located on the back of the game controller assembly 1200 alongside the inner curve 1208b of the ergonomic contoured protrusion 1204a, 1204b. This location is particularly advantageous as it can be activated by the fingers of the user while the game controller assembly 1900 is in play without requiring any additional hand movements. The microphone button 1212 could be a toggle switch or a momentary switch, or it could be software controlled and configured according to the user's preference. The microphone 1906 transmits voice data through the MCU 109 and through the user computing device 135 software applications (not shown).

In addition indicator lights 1908, 1910 will inform the user of different situations, including but not limited to, when he/she has voice communication enabled or is transmitting voice data. In one embodiment, there are two lights 1908, 1910 on the front of the game controller assembly 1900 as depicted in FIG. 19. In one embodiment, the left light 1908 is blue and has a volume indicator symbol. This light 1908 is activated when the game controller assembly 1900 is receiving incoming voice data from the user computing device 135. The light 1910 on the right is orange and has a microphone symbol. This light 1910 is activated when the microphone 1906 is active and is sending voice data to the user computing device 135. The lights 1908, 1910 can be comprised of an LED or other small light. They are powered off the battery 102 of the game controller assembly 1900.

FIG. 19 shows several optional locations for a preference-based software button 1902, 1904 for media. This button 1902, 1904 could have different software controlled settings allowing it to offer different functions including but not limited to, screen capture and video recording. The social media button 1902, 1904 could also provide multiple functions by utilizing software controlled multi-push codes. In one embodiment, the button 1902, 1904 is pressed once to capture and save the current image present on the screen. To activate video record, the social media button 1902, 1904 is pressed and released twice in succession. This begins recording the images on the screen of the user computing device 135 as a video. The video record is ended by pressing and releasing the social media button 1902, 1904 one additional time. The image and video data can be saved to storage of the user computing device 135 or storage 111 of the game controller assembly 1900. When the video record mode is active, the software of the game controller assembly 1900 causes a red dot symbol to be displayed on the screen of the user computing device 135 in the top right corner. This red dot is not saved in any video record data. When video record mode is deactivated, the red dot ceases being displayed on the screen of the user computing device 135. In other embodiments, the social media button 1902, 1904 can be linked via software to other media software in order to facilitate the sharing of screen images with other viewers. In one example, the social media button 1902, 1904 is linked to a live video streaming service wherein video sharing of the user computing device 135 is controlled (started, paused, stopped) by the social media button the user computing device 135.

What is claimed is:

1. A device for controlling and interacting with a video game operating on a computing device, the device comprising:
a plurality of input devices for receiving user input;
a connector for coupling to the computing device;
a processor coupled to the plurality of input devices and the connector for receiving the user input from the plurality of input devices and communicating with the computing device; and
a chassis defining an opening for removably holding the computing device, the opening sized to surround edges of the computing device leaving portions a top and a bottom of the computing device uncovered, the chassis housing the plurality of input devices, the connector and the processor, the connector coupling with the computing device when the computing device is positioned in the opening.

2. The device of claim 1, wherein the computing device is secured in the opening of the chassis by a retaining lip, the retaining lip made of rubber silicon and positioned around the periphery of the opening such that the computing device can slide past the retaining lip into the opening for secure mounting inside the opening.

3. The device of claim 1, wherein the plurality of input devices includes a pair of trigger buttons mounted on the side of the chassis, a first set of buttons on the top of the chassis, at least one joystick on mounted partially recessed in the chassis and cooperating with a first printed circuit board and a second printed circuit board to interface with the processor.

4. The device of claim 1, wherein the plurality of input devices includes a first pair of trigger buttons mounted to rotate about a first axis of the chassis and a second pair of trigger buttons mounted to rotate about a second axis of the chassis, the first axis being substantially orthogonal to the second axis.

5. The device of claim 1, wherein at least one of the plurality of input devices is a button for controlling social media interaction, the button controlling one from the group of audio capture, screen capture, video capture and voice integration.

6. The device of claim 5, further comprising an output device for providing feedback to the user as to a status of social interaction.

7. The device of claim 1, further comprising a data storage, the data storage housed in the chassis and coupled to the processor.

8. The device of claim 1, wherein the chassis houses a battery, the battery coupled to the processor to provide power to the processor, and coupled to the connector to provide power to the computing device.

9. The device of claim 1, wherein the chassis forms an audio refraction channel from a speaker of the computing device to the surface of the chassis, the audio refraction providing sound amplification.

10. A device for controlling and interacting with a video game operating on a computing device, the device comprising:
a case for removably holding the computing device; and
a game controller assembly having a plurality of input devices for receiving user input; a connector for coupling to the computing device; a processor coupled to the plurality of input devices and the connector for receiving the user input from the plurality of input devices and communicating with the computing device; and a chassis defining an opening for removably holding the case, the opening sized to surround edges of the case leaving portions a top and a bottom uncovered to expose a surface of the computing device held by the case, the chassis housing the plurality of input devices, the connector and the processor, the connector coupling with the computing device when the case and computing device are positioned in the opening.

11. The device of claim 10, wherein the case is secured in the opening of the chassis by a mounting mechanism.

12. The device of claim 11, wherein the case has a plurality of pin extending outward from sides of the case, and wherein the mounting mechanism is at least a pair of corresponding slot defined by the chassis that mate with the pins and securely hold the case in the opening of the chassis.

13. The device of claim 12, wherein the pair of slots include an angled slot and a vertical slot with a passive locking mechanism.

14. The device of claim 10, wherein the plurality of input devices includes a pair of trigger buttons mounted on the side of the chassis, a first set of buttons on the top of the chassis, at least one joystick on mounted partially recessed in the chassis and cooperating with a first printed circuit board and a second printed circuit board to interface with the processor.

15. The device of claim 10, wherein the plurality of input devices includes a first pair of trigger buttons mounted to rotate about a first axis of the chassis and a second pair of trigger buttons mounted to rotate about a second axis of the chassis, the first axis being substantially orthogonal to the second axis.

16. The device of claim 10, wherein at least one of the plurality of input devices is a button for controlling social media interaction, the button controlling one from the group of audio capture, screen capture, video capture and voice integration.

17. The device of claim 16, further comprising an output device for providing feedback to the user as to a status of social interaction.

18. The device of claim 10, further comprising a data storage, the data storage housed in the chassis and coupled to the processor.

19. The device of claim 10, wherein the chassis houses a battery, the battery coupled to the processor to provide power to the processor, and coupled to the connector to provide power to the computing device.

20. The device of claim 10, wherein the chassis forms an audio refraction channel from a speaker of the computing device to the surface of the chassis, the audio refraction providing sound amplification.
